(19) United States
(12) Patent Application Publication
(10) Pub. No.: US 2025/0026336 A1
(43) Pub. Date: Jan. 23, 2025

(54) PARKING ASSISTANCE DEVICE, PARKING ASSISTANCE METHOD, AND PARKING ASSISTANCE RECORDING MEDIUM

(71) Applicant: Panasonic Automotive Systems Co., Ltd., Kanagawa (JP)

(72) Inventors: Yoshimasa OKABE, Kanagawa (JP); Hirofumi NISHIMURA, Kanagawa (JP); Manabu NAKAKITA, Kanagawa (JP)

(73) Assignee: Panasonic Automotive Systems Co., Ltd., Kanagawa (JP)

(21) Appl. No.: 18/777,305

(22) Filed: Jul. 18, 2024

(30) Foreign Application Priority Data
Jul. 20, 2023 (JP) 2023-118336

(51) Int. Cl. B60W 30/06; B60W 10/18; B60W 10/20; B60W 10/30; G08G 1/14

(52) U.S. Cl. CPC B60W 30/06; B60W 10/18; B60W 10/20; B60W 10/30; G08G 1/14

(57) ABSTRACT

A parking assistance device includes: a parking slot detector that detects a parking slot; an operation receiver that receives a parking instruction operation of a passenger of a vehicle; and a travel controller that performs automatic parking of the vehicle in a parking slot corresponding to the parking instruction operation. When the parking slot is located on only one of left and right sides in a travelling direction of the vehicle, or when the parking instruction operation is a parking instruction operation including a direction instruction and the parking slot is located in a direction instructed by the parking instruction operation, in a case where the parking slot is located in a predetermined range in the travelling direction of the vehicle, it is determined that the parking slot corresponds to the parking instruction operation.

### TECHNICAL FIELD

The present disclosure relates to a parking assistance device, a parking assistance method, and a parking assistance recording medium.

### BACKGROUND ART

In the related art, a parking assistance device is known that detects a parking slot around a vehicle and display it on an image, and automatically parks the vehicle in the parking slot when the driver selects the parking slot or the parking direction. For example, PTL 1 discloses a configuration in which when a plurality of available parking positions is detected, the available parking positions are displayed on a display device and the target parking position is selected from among the displayed available parking positions.

### CITATION LIST

### Patent Literature

### PTL 1

Japanese Patent Application Laid-Open No. 2021-94927

### SUMMARY OF INVENTION

### Technical Problem

However, since the driver is required to look forward during travel, the configuration of the known technology requires the vehicle to stop before looking and operating the image. At the same time, smooth automatic parking is required in some situation. For example, in a situation where a line of vehicles waiting to park are parked one after another in forward parking, it is annoying to operate the parking assistance device by stopping the vehicle on the passage, and the following vehicle may honk at the horn.

An object of the present disclosure is to provide a parking assistance device, a parking assistance method, and a parking assistance program that can smoothly perform automatic parking without requiring vehicle stop.

### Solution to Problem

To solve the above-mentioned problems, a parking assistance device according to an aspect of the present disclosure includes: a parking slot detector that detects a parking slot; an operation receiver that receives a parking instruction operation of a passenger of a vehicle; and a travel controller that performs automatic parking of the vehicle in a parking slot corresponding to the parking instruction operation. When the parking slot is located on only one of left and right sides in a travelling direction of the vehicle, or when the parking instruction operation is a parking instruction operation including a direction instruction and the parking slot is located in a direction instructed by the parking instruction operation, in a case where the parking slot is located in a predetermined range in the travelling direction of the vehicle, it is determined that the parking slot corresponds to the parking instruction operation.

A parking assistance method according to an aspect of the present disclosure includes: detecting a parking slot; receiving a parking instruction operation of a passenger of a vehicle; determining that the parking slot corresponds to the parking instruction operation when the parking slot is located on only one of left and right sides in a travelling direction of the vehicle, or when the parking instruction operation is a parking instruction operation including a direction instruction and the parking slot is located in a direction instructed by the parking instruction operation, in a case where the parking slot is located in a predetermined range in the travelling direction of the vehicle; and performing automatic parking of the vehicle in a parking slot corresponding to the parking instruction operation.

A parking assistance recording medium according to an aspect of the present disclosure causes a computer to execute: detecting a parking slot; receiving a parking instruction operation of a passenger of a vehicle; determining that the parking slot corresponds to the parking instruction operation when the parking slot is located on only one of left and right sides in a travelling direction of the vehicle, or when the parking instruction operation is a parking instruction operation including a direction instruction and the parking slot is located in a direction instructed by the parking instruction operation, in a case where the parking slot is located in a predetermined range in the travelling direction of the vehicle; and performing automatic parking of the vehicle in a parking slot corresponding to the parking instruction operation.

### Advantageous Effects of Invention

According to the present disclosure, it is possible to smoothly perform automatic parking without requiring vehicle stop.

### BRIEF DESCRIPTION OF DRAWINGS

FIG. 1A is a diagram illustrating front quick parking according to the present embodiment;

FIG. 1B is a diagram illustrating the front quick parking according to the present embodiment;

FIG. 2A is a diagram illustrating a steering limitation point according to the present embodiment;

FIG. 2B is a diagram illustrating the steering limitation point according to the present embodiment;

FIG. 2C is a diagram illustrating the steering limitation point according to the present embodiment;

FIG. 3A is a diagram for mathematically describing the steering limitation point according to the present embodiment;

FIG. 3B is a diagram for mathematically describing the steering limitation point according to the present embodiment;

FIG. 4A is another diagram for mathematically describing the steering limitation point according to the present embodiment;

FIG. 4B is another diagram for mathematically describing the steering limitation point according to the present embodiment;

FIG. 5A is a diagram illustrating points of interest in vehicle control;

FIG. 5B is a diagram illustrating points of interest in vehicle control;

FIG. 5C is a diagram illustrating points of interest in vehicle control;

FIG. 6 is a diagram illustrating a vehicle that can adopt a parking assistance device;

FIG. 7 is a diagram illustrating a configuration on the network of a system to which the parking assistance device is applied;

FIG. 8 is a block diagram illustrating hardware for implementing a function of the parking assistance device;

FIG. 9 is a block diagram illustrating the parking assistance device;

FIG. 10 is a diagram illustrating an example of setting of a parking slot detection region;

FIG. 11 is a diagram illustrating a parking path;

FIG. 12 is a diagram illustrating a procedure of automatic parking control according to the present embodiment;

FIG. 13 is a diagram illustrating a procedure of automatic parking control according to the present embodiment;

FIG. 14 is a diagram illustrating a procedure of automatic parking control according to the present embodiment;

FIG. 15 is a diagram illustrating a procedure of automatic parking control according to the present embodiment;

FIG. 16 is a diagram illustrating a state before a detection of a parking slot;

FIG. 17A is a diagram illustrating a confirmation point;

FIG. 17B is a diagram illustrating a confirmation point;

FIG. 18 is a diagram illustrating a configuration for detecting the next parking slot;

FIG. 19 is a diagram for describing a message output for a case where there are successive empty parking slots;

FIG. 20 is a diagram for describing a configuration of starting deceleration when a parking slot is detected;

FIG. 21 is a diagram illustrating a configuration for decelerating the vehicle so as not to go beyond a steering limitation point;

FIG. 22 is another diagram illustrating a configuration for decelerating the vehicle so as not to go beyond the steering limitation point; and

FIG. 23 is a diagram illustrating a configuration for a case where parking instruction is made by a steering wheel operation.

### DESCRIPTION OF EMBODIMENTS

Embodiments of the present disclosure are described below with reference to the drawings. The forms of implementation described below are all specific examples of the present disclosure. Therefore, each component, the position of each component and the connection form, as well as each step and the order of each step, etc., shown in the following forms are examples and are not intended to limit the present disclosure. In addition, components in the following embodiments that are not described in the independent claims are described as optional components.

Each drawing is a schematic diagram and is not necessarily a strict illustration. In each drawing, the same symbol is attached to a substantially identical configuration, and redundant explanations are omitted or simplified.

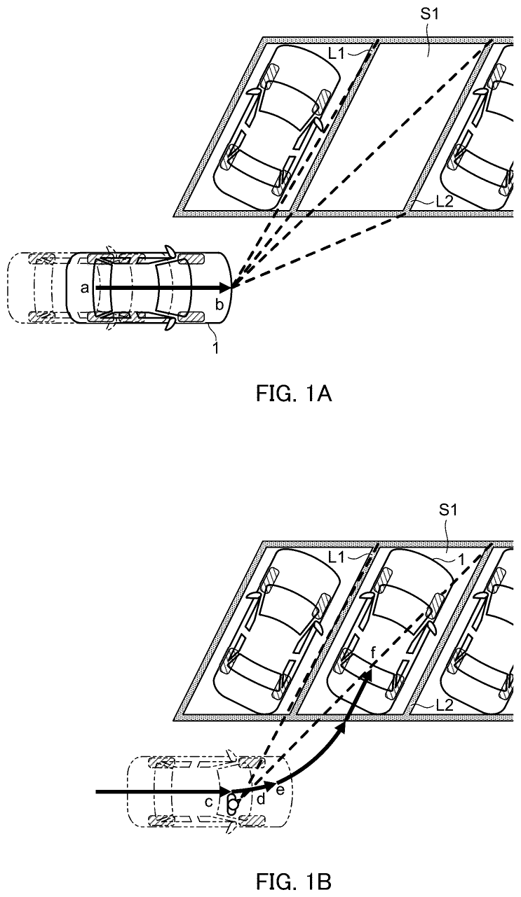

FIGS. 1A and 1B are diagrams illustrating front quick parking according to the present embodiment. Parking slot S1 is a parking slot sandwiched by parking slot lines L1 and L2.

The front quick parking basically includes the following six steps (see a to fin FIGS. 1A and 1B).
A. When the parking slot detection function is activated during travel, vehicle 1 describes the procedure of forward parking operation.
B. When detecting an empty parking slot, vehicle 1 provides a notification to the driver and urges the driver to decelerate, or it automatically decelerates.
C. The driver visually confirms the inside of parking slot S1, and performs a parking instruction operation of designating the parking position with the steering wheel and the like.
D. When receiving the parking instruction operation, vehicle 1 vibrates the steering wheel (reception response).
E. When the driver releases the hand from the steering wheel (approval operation), vehicle 1 starts the automatic travelling.
F. When automatically travelled to the target parking position, vehicle 1 stops.

The front quick parking has the following features. First, the driver does not need to look at the detected parking slot S1 on the screen. In addition, the driver does not need to designate the target parking position on the screen. As such, the driver does not need to stop for screen confirmation or operation, and therefore automatic parking can be performed by activating the automatic parking function in a non-stop manner. Note that here, the driver or a passenger on the front passenger seat may be referred to simply as passenger.

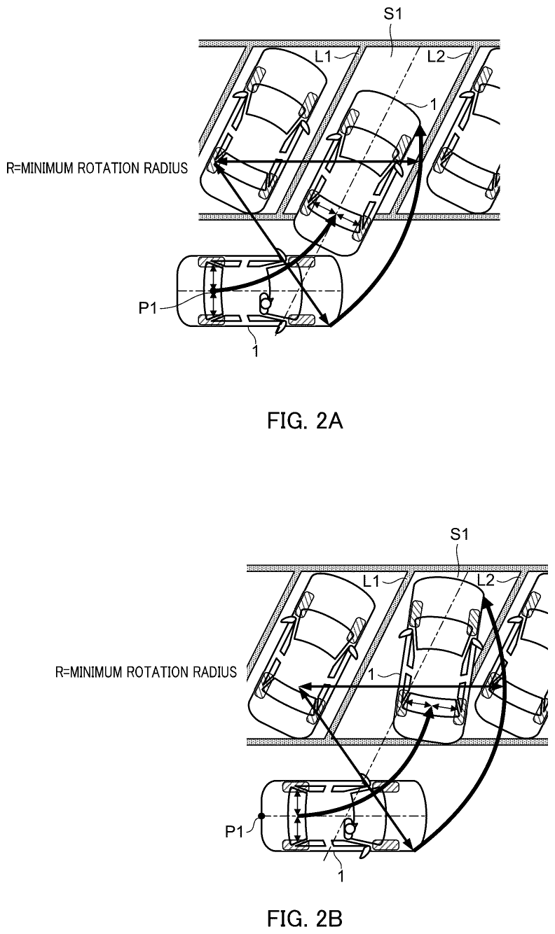

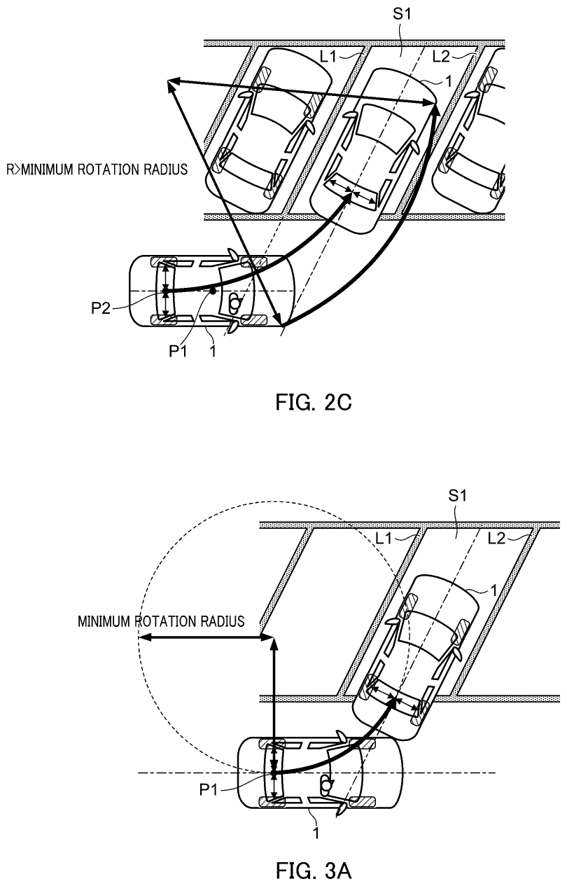

FIGS. 2A to 2C are diagrams illustrating a steering limitation point according to the present embodiment. As illustrated in FIG. 2A, steering limitation point P1 refers to a point where to turn vehicle 1 to park within parking slot S1 with a minimum rotation radius while travelling on a passage. Steering limitation point P1 serves as a reference for setting a steering position (steering point P2). When a parking slot S1 is detected, the position (steering point P2) for steering toward parking slot S1 is set on the course of vehicle 1 as illustrated in FIG. 2C, and vehicle 1 is controlled such that steering can be made at steering point P2.

As illustrated in FIG. 2B, when vehicle 1 goes over steering limitation point P1, vehicle 1 may not be properly parked within parking slot S1 or collide with a parked vehicle even when vehicle 1 turns with the minimum rotation radius, and therefore the parking instruction operation cannot be accepted at a position beyond steering limitation point P1. In view of this, steering point P2 is set within a range not exceeding steering limitation point P1, and the reception of the parking instruction operation is terminated before steering point P2 is exceeded. That is, the end point of the reception range of the parking instruction operation is set within a range not exceeding steering limitation point P1.

The reception range of the parking instruction operation is a predetermined range on the course of the vehicle, and the entrance to the parking slot is located in the travelling direction from the reception range. In view of this, the state where the vehicle is located in the reception range of the parking instruction operation is referred to as the state where the parking slot is located in a predetermined range in the travelling direction of the vehicle. This corresponds to the configuration in which the position of the parking slot is detected based on the position of the vehicle, and steering limitation point P1 is set based on the position of the parking slot. Since steering point P2 and steering limitation point P1 are examples of the predetermined steering point, the terminal end of the predetermined range may be said to be set based on the predetermined steering point.

As illustrated in FIG. 2C, setting steering point P2 before steering limitation point P1 can set a parking path along which vehicle 1 can be properly parked within parking slot S1 by turning with a rotation radius greater than the minimum rotation radius. If the parking path includes an arc of turning at a minimum rotation radius, the steering angle cannot be increased when the vehicle is deviated to the outside of the arc, and therefore the vehicle cannot be reset to the parking path. In view of this, it is preferable to set steering point P2 before steering limitation point P1 such that the rotation radius is greater than the minimum rotation radius.

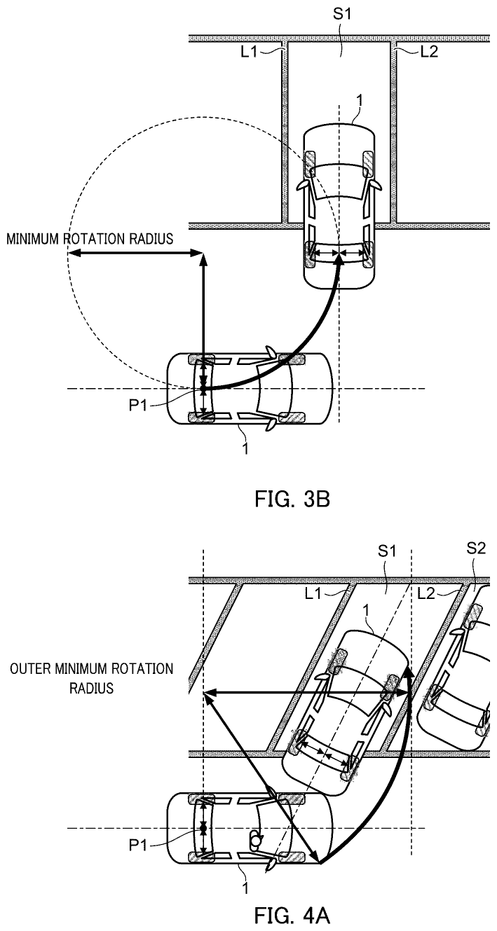

FIGS. 3A and 3B are diagrams for mathematically describing steering limitation point P1 according to the present embodiment. In the case where the radius of a circle drawn by the middle point of the two rear wheels when vehicle 1 turns at a maximum steering angle is set as a minimum rotation radius, and a circle is drawn with the minimum rotation radius in contact with both the center line (a line that is parallel to parking slot lines L1 and L2 of parking slot S1 and is equidistant from parking slot lines L1 and L2) of the parking slot and a straight line (which may be, for example, a line passing through the center of the passage) representing the advancing direction of the own vehicle, the contact point of the circle and the straight line representing the advancing direction of the own vehicle is steering limitation point P1.

In the case where the torque of the EPS (Electric Power Steering) is small, the rotation radius may be larger than in the case of manual turn. In addition, the rotation radius may be increased due to the vehicle speed and the road surface conditions, and therefore it is possible to set effective steering limitation point P1′ with a distance margin before theoretical steering limitation point P1.

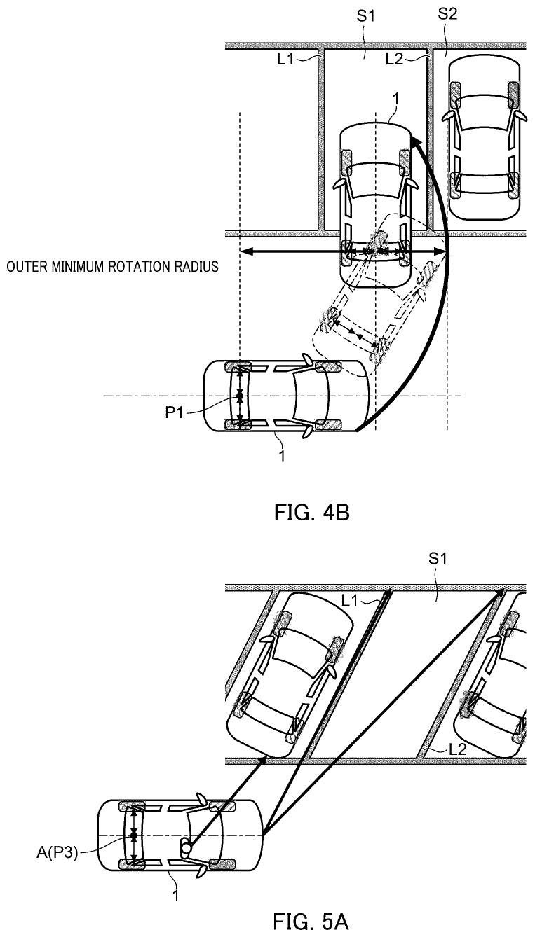

FIGS. 4A and 4B are other diagrams for mathematically describing steering limitation point P1 according to the present embodiment. The radius of the circle drawn by the corner on the side further from the turning center in the case where vehicle 1 turns at a maximum steering angle is referred to as outer minimum rotation radius. In the case where there is a parked vehicle in parking slot S2 next to empty parking slot S1, steering limitation point P1 may be determined based on the outer minimum rotation radius.

During the parking, it is necessary to prevent the approach to the parked vehicle, which takes precedence over parking in the center of parking slot S1. In this case, when steering limitation point P1 is set such that the turning center is a position separated from the parked vehicle by the outer minimum rotation radius, the parking can be achieved with no risk of collision. That is, it is preferable to change the setting of steering limitation point P1 depending on the presence/absence of the parked vehicle.

Note that since occupants may startle when a corner of the vehicle body approaches the parked vehicle, effective steering limitation point P1′ may be set with a distance margin before theoretical steering limitation point P1.

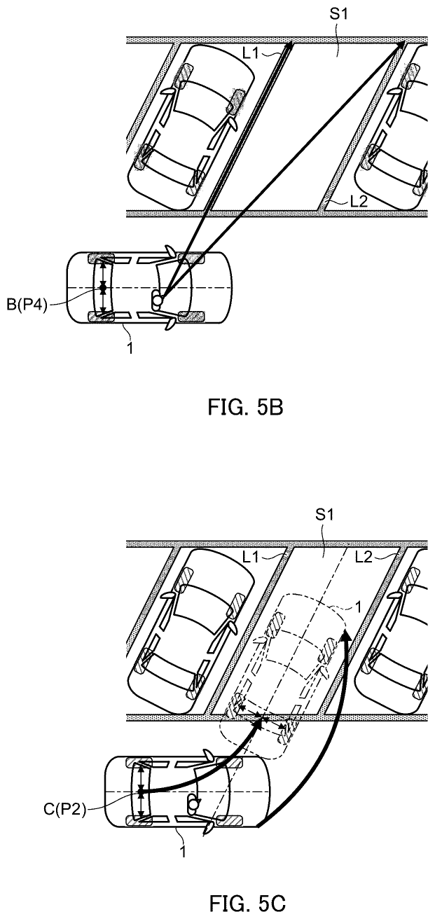

FIGS. 5A to 5C are diagrams illustrating points of interest in vehicle control. In the following description, the representative point of the position of vehicle 1 is set as the middle point of the grounded points of the left and right rear wheels, and the position of the representative point is set as the position of vehicle 1.

FIG. 5A is a diagram illustrating a state where empty parking slot S1 is detected while vehicle 1 travels through a passage facing a parking slot, and point A (detection point P3) represents the position of vehicle 1 at the time when empty parking slot S1 is detected. When the camera provided in vehicle 1 reaches the extension of parking slot line L1 on the near side of empty parking slot S1, it is possible to detect the parking slot that is not blocked on the camera image even when there is a parked vehicle. When there is no parked vehicle, detection point P3 may be set based on the detection range of the parking slot detection. That is, detection point P3 is influenced by the presence/absence of the parked vehicle.

Point B (confirmation point P4) in FIG. 5B is a confirmation point where a passenger can confirm the inside of empty parking slot S1, and when the driver reaches the extension of parking slot line L1 on the near side of empty parking slot S1, the driver can confirm the inside of empty parking slot S1. Confirmation point P4 may be a point where the inside of empty parking slot S1 can be confirmed on the camera image. That is, confirmation point P4 and detection point P3 may be the same point.

Specifically, the confirmation point may be set based on the positional relationship between the head of a passenger such as the driver or the camera provided in vehicle 1, and the extension of parking slot line L1, which is the long side of the parking slot. In addition, confirmation point P4 is also influenced by the presence/absence of the parked vehicle, and therefore confirmation point P4 may be set based on detection point P3. For example, when parking slot S1 is detected before the extension of parking slot line L1, it is possible to determine that confirmation point P4 is exceeded at the time point of the detection by estimating that there is no parked vehicle in the slot on the near side and that parking slot S1 can be visually confirmed. Alternatively, when there is no parked vehicle in the slot on the near side, the reference position for setting confirmation point P4 may be set at a position shifted to the near side by a predetermined distance (e.g., 4 m).

As illustrated in FIG. 5C, point C (steering point P2) is a position where the vehicle starts the steering. Steering point P2 is set on the near side than steering limitation point P1.

If the parking instruction operation is received before the passenger becomes able to confirm the inside of empty parking slot S1, inconvenience may occur when automatic parking is started. In view of this, it is preferable to limit the reception range of the parking instruction operation within the range from point B (confirmation point P4) as the start point to steering point P2 as the end point. Point B (confirmation point P4) is an example of the predetermined confirmation point, and therefore it can be said that the starting end of the predetermined range is set based on the predetermined confirmation point.

In addition, in view of the configuration in which the location information of the parking slot is detected based on the position of the vehicle at the time of detection while the predetermined range is determined based on the location information of the parking slot, starting the automatic parking when the parking instruction operation is received in the predetermined range may be referred to as starting the automatic parking when it is determined that the parking slot corresponds to the parking instruction operation by determining that the parking slot corresponds to the parking instruction operation when the parking slot is located in the predetermined range in the travelling direction of the vehicle.

The parking instruction operation is performed for the device of the vehicle described below, and the information about reception of the parking instruction operation is provided to the parking assistance device, and, the parking assistance device determines the correspondence. The parking instruction operation may be one or a combination of the operation of rotating the steering wheel, the operation of moving down the blinker lever, turning on the hazard lamp, the operation of the brake pedal, and the operation of a predetermined button. For example, when the operation of the brake pedal and the operation of moving down the blinker lever are simultaneously performed or are performed within a predetermined time, it is possible to determine that a parking instruction operation has been performed.

Among them, the operation of rotating the steering wheel, the operation of moving down the blinker lever, and the operation of the button indicating the direction may be referred to as the parking instruction operation including the direction instruction. The button indicating the direction displayed on the touch panel is an example of the predetermined button. For example, when a semi-transparent rectangle representing a detected parking slot is superimposed on the image displayed on the touch panel and there is an operation of touching the rectangle, it is possible to determine that there is the operation of a predetermined button including the direction instruction.

When there is a parking slot on the left or right side in the travelling direction of the vehicle, or when the parking instruction operation is the parking instruction operation including the direction instruction and there is a parking slot in the direction instructed by the parking instruction operation, in the case where the parking slot is located in a predetermined range in the travelling direction of the vehicle, it is determined that the parking slot corresponds to the parking instruction operation. That is, when there is a parking slot only on the left or right side in the travelling direction of the vehicle, the parking instruction operation not including the direction instruction can be used, but when there are parking slots on both the left and right sides in the travelling direction of the vehicle, the parking instruction operation including the direction instruction is required.

In addition, when there is a parking slot only on the left or right side in the travelling direction of the vehicle and the parking instruction operation does not include the direction instruction, it is possible to determine that there is a correspondence without evaluating the direction provided that the parking slot is located in a predetermined range in the travelling direction of the vehicle. For example, when a parking slot is detected only on the left side of the passage and a brake operation of decelerating to a slow speed is performed on the near side of the steering point, the automatic parking may be started by regarding the brake operation as the parking instruction operation.

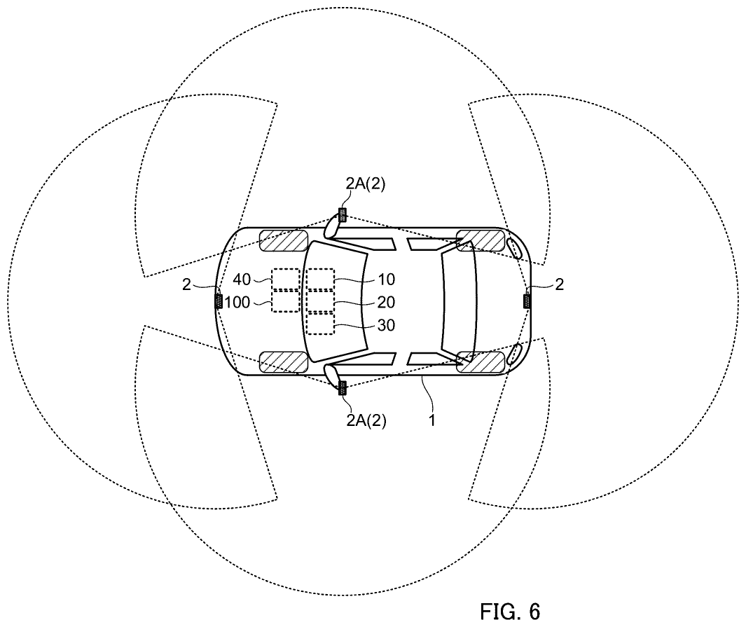

FIG. 6 is a diagram illustrating a vehicle that can adopt the parking assistance device. As illustrated in FIG. 6, camera 2 is provided at four locations, front, rear, left and right, of the body of vehicle 1. Each camera 2 includes a fish eye lens, and has a field of view range of 180 degrees or greater in the horizontal direction (see the broken line).

Each camera 2 is mounted with a depression angle to capture the road surface, and when the capturing range of the road surface is converted to the field of view in the horizontal direction, single camera 2 captures the road surface in the range of about 240 degrees. For example, the front wheel, the rear wheel, and the side surface of the vehicle body are captured in the captured images of side cameras 2A provided at the left and right of vehicle body.

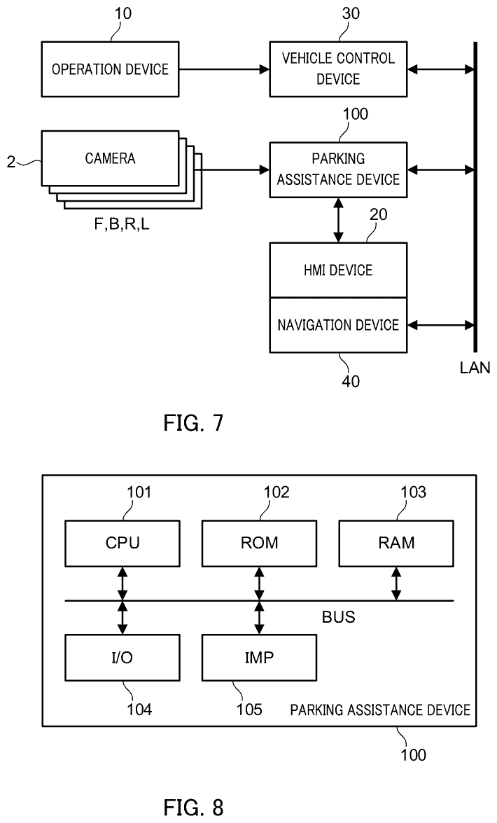

In addition, FIG. 7 is a diagram illustrating a configuration on the network of a system to which parking assistance device is applied. As illustrated in FIG. 7, vehicle 1 includes, in addition to the four cameras 2, operation device 10, HMI (human machine interface) device 20, vehicle control device 30, and parking assistance device 100.

Operation device 10 is configured to be manually operated by the driver (passenger), and includes physical switches on the panel of the driver's seat, software-like switches displayed on the touch panel, and components for driving operations such as the steering wheel, pedal, and gear.

HMI device 20 is used as an HMI for the passenger to perform input operation to parking assistance device 100 such as a touch panel of navigation device 40 provided in vehicle 1, for example. The touch panel may be included in operation device 10, and various switches disposed at the driver's seat may be included in operation device 10, and therefore, operation device 10 and HMI device 20 may overlap each other.

As illustrated in FIG. 8, parking assistance device 100 and vehicle control device 30 include a CPU (central processing unit), a ROM (read only memory), a RAM (random access memory) and input/output circuit (I/O). For example, when the passenger operates operation device 10, the input/output circuit (I/O) of vehicle control device 30 receives the operation, and the CPU determines the operation corresponding to the operation. The same applies to parking assistance device 100.

In the normal operation mode, vehicle control device 30 drives the motor (not illustrated in the drawing) in accordance with the operation information to control the steering angle and the vehicle speed, and outputs to the LAN (Local Area Network: e.g., in-vehicle LAN) the operation information and vehicle information such as information about the steering angle and information about the vehicle speed. When the automatic travelling mode is set, vehicle control device 30 receives the command of speed or the steering angle from parking assistance device 100 via the LAN, and controls the speed and the steering angle in accordance with the command.

Since vehicle control device 30 monitors the operation of operation device 10 for driving, parking assistance device 100 can acquire the operation information of operation device 10 via the LAN. Parking assistance device 100 can acquire the information about the operation performed by the passenger through HMI device 20. Parking assistance device 100 may receive the location information of vehicle 1 output by navigation device 40 via the LAN, or may directly acquire it from navigation device 40.

Camera 2 outputs the captured image to parking assistance device 100 at all times, and even when not performing parking assistance, parking assistance device 100 generates the display image representing the surroundings of the vehicle from the captured image, and outputs the image.

In addition, the above-mentioned touch panel functions also as the display that outputs the display image generated by parking assistance device 100, and therefore parking assistance device 100 and HMI device 20 may be directly connected to each other.

Parking assistance device 100 may directly sense information about the operation performed on the touch panel, or may receive the information via the LAN. In addition, parking assistance device 100 can receive via the LAN the location information of vehicle 1 output by navigation device 40.

In addition, the function of parking assistance device 100 may be implemented by the hardware illustrated in FIG. 8. Parking assistance device 100 includes CPU 101, ROM 102, RAM 103, I/O (input and output interface) 104 and IMP (Image Processor) 105. Parking assistance device 100 may be a computer that connects each element through a bus.

In addition, a plurality of elements may be housed in one chip, or one element may be composed of a plurality of chips. The bus may not be a single bus, but may be a combination of buses of a plurality of types.

For example, CPU 101, ROM 102, RAM 103 and IMP 105 housed in one chip may be connected by a parallel bus, and I/O 104 composed of a plurality of chips may be connected by a serial bus to a chip that houses CPU 101 and the like.

CPU 101 controls the entirety of parking assistance device 100. ROM 102 is an electrically rewritable memory, and stores the program to be executed by CPU 101 and functions as a nonvolatile data storage region to retain the data and the like even when the power of parking assistance device 100 is turned off.

RAM 103 is used for temporary storage as the work area of CPU 101. For example, data that only needs to be temporarily stored such as the latest peripheral image is stored in RAM 103. RAM 103 has the capacity to store a plurality of peripheral images.

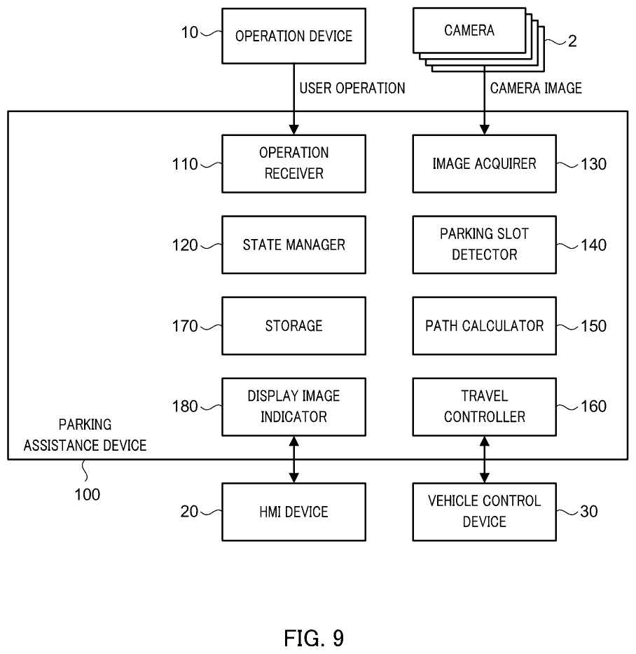

IMP 105 is a processor with a large processing capacity specialized in image processing, and implements the image processing at image acquirer 130, parking slot detector 140, and display image indicator 180 illustrated in FIG. 9.

The above-described camera 2 outputs captured camera images to parking assistance device 100 at all times. Parking assistance device 100 generates, from the camera image, display images representing the surroundings of vehicle 1 even when not performing parking assistance.

FIG. 9 is a block diagram illustrating the parking assistance device. As illustrated in FIG. 9, parking assistance device 100 includes operation receiver 110, state manager 120, image acquirer 130, parking slot detector 140, path calculator 150, travel controller 160, Storage 170, and display image indicator 180.

Operation receiver 110 receives operation information representing the driver's operation including the driving operation. State manager 120 manages the state of the parking assistance in accordance with the operation information and the state of the vehicle, and receives the driver's operation for each state so as to achieve the function of automatic parking as a whole. states of the parking assistance are elaborated later.

Image acquirer 130 acquires camera images and generates peripheral images representing the surroundings of vehicle 1. The peripheral image may be a bird's-eye view obtained by projecting a camera image on the road surface, or an image of another format, or, a camera image as it is. In the present embodiment, the peripheral image is a bird's-eye view.

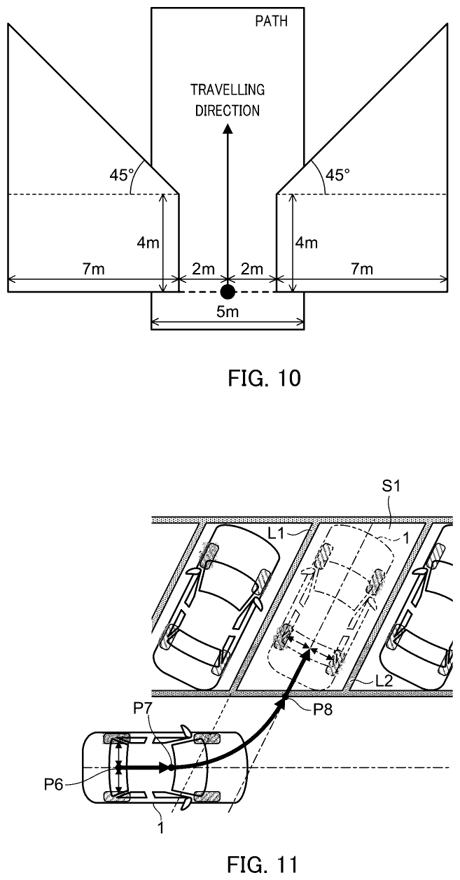

FIG. 10 is a diagram illustrating an example of setting of a parking slot detection region. Parking slot detector 140 sets a parking slot detection region for detecting the parking slot in the peripheral image, and extracts a white line from the peripheral image in the parking slot detection region. The parking slot detection region may be the entire region of the peripheral image, or a limited region to expect a parking slot in the peripheral image.

Limiting the parking slot detection region to the region to expect the parking slot can reduce the processing time required for detection. In addition, limiting the size of the parking slot detection region to a size that accommodates one parking slot but does not accommodate two parking slots can eliminate the processing for the case where two parking slots are simultaneously detected.

FIG. 10 is a diagram illustrating an example of setting of the parking slot detection region for forward parking. It is assumed that front camera 2 is attached to the center of the front end of vehicle 1, and that vehicle 1 travels in the center of the passage and can park in left and right parking slots.

It is assumed that parking slot has a width of 2.5 m, the long side of the parking slot has a length of 5 m, the passage has a width of 5 m, and the angle the parking slot (slot line) with respect to the travelling direction is 45 degrees to 90 degrees. When the angle of the parking slot is an obtuse angle (e.g., 105 degrees or greater) with respect to the travelling direction, backward parking is required. Therefore, in the case of the forward parking, even when there is an empty parking slot at an obtuse angle with respect to the travelling direction, it is not determined to be detected.

The setting of the parking slot detection region may be changed in accordance with the detection result and the circumstances. For example, in the case where a white line approximately parallel to the travelling direction of vehicle 1 is detected on the left and right sides of the vehicle, it is recognized that the white line indicates the passage, and therefore the direction of the white line can replace the reference direction of the parking slot detection region. In addition, since vehicle 1 may travel close to one side of the passage, it is preferable to offset the parking slot detection region left and right such that the left and right white lines are included in the left and right parking slot detection regions.

Further, parking slot detector 140 generates pairs of extracted white lines, and searches for a pair that matches the parking slot condition from among the pairs of white lines. For example, when parking slot detector 140 detects a pair of white lines in the peripheral image, parking slot detector 140 determines that the region between the two white lines is a region where vehicle 1 can be parked (i.e., a parking slot) provided that the following three conditions are satisfied, namely, the two white lines are parallel to each other on the road surface, the two white lines are longer than the vehicle length, and the distance between the two white lines are is greater than the vehicle width.

In general, the detection is performed for the purpose of obtaining information about specific objects, and when a specific object is detected as a result, it is determined to be “detected”, and, information about the detected object is output. The detection results are divided into two categories: detected and not detected, and the object of the detection is not achieved in the case where of not detected. In the case of detected, the object of detection is achieved, and therefore the case of detected may be said to be successful detection. For example, in the case of successful detection of a parking slot, the location information of the parking slot is obtained as a detection result.

When a parking slot is detected, the white line making up the parking slot can be said to be a parking slot line, and therefore parking slot detector 140 outputs as a detection result the coordinates of the endpoints of the two parking slot lines, i.e., the coordinates of the four corners of the parking slot. These coordinates are relative coordinates with respect to the own vehicle as a reference. Note that when another vehicle is parked in the parking slot, the parking slot is not detected because at least one of parking slot lines is hidden. That is, while the detected parking slot is an empty parking slot, it may be simply referred to as parking slot.

FIG. 11 is a diagram illustrating a parking path. Path calculator 150 sets the target parking position such that the center of vehicle body 1 is set at the center of the coordinates of the four corners of parking available region S1 output by parking slot detector 140, and sets the target parking angle (the orientation of the vehicle body when parked at the target parking position) such that it is parallel to long sides L1 and L2 of the parking available region so as to calculate the parking path to the target parking position.

When the parking path is calculated with position P6 where the automatic parking is approved as the steering point, the path changes depending on the approval time point of the automatic parking, and as such it is difficult to complete the path calculation under the time constraint. In view of this, path calculator 150 sets steering point P7 at the end of the half-line extended in the travelling direction of vehicle 1 (P6), and sets a circle that is in contact with both the half-line (P6-P7) and the center line of parking slot S1, with a radius slightly larger than the minimum rotation radius.

For example, path calculator 150 sets steering point P7 as the contact point of the circle and the half-line, and turning end point P8 as the contact point of the circle and the center line, and sets a straight path from the current position of vehicle 1 to steering point P7, a path for travelling on the circumference with a constant steering angle from steering point P7 to turning end point P8, and a straight path from turning end point P8 to the parking target position. That is, the parking path is calculated assuming straight movement up to steering point P7 regardless of the approval time point of the automatic parking.

When the radius of the circle is greater than the minimum rotation radius, it can be said to be a favorable path because even the travelling path of vehicle 1 deviated from the circular trajectory (P7-P8) to the outside can be reset to the calculated path through the control of the steering angle.

This path cannot be applied if vehicle 1 goes over steering point P7 before the approval of the automatic parking, and therefore it suffices to set the reception timing of the parking instruction through inverse operation such that the automatic parking is approved before steering point P7. For example, in the case where it takes one second from reception of a parking instruction to determination of approval of automatic parking, the reception end time point may be set one second before vehicle 1 reaches steering point P7, and a notification such as “skipped” indicating that automatic parking has not been started may be provided when the reception end time point is exceeded.

Travel controller 160 controls the steering angle and the vehicle speed such that vehicle 1 travels along calculated parking path. More specifically, travel controller 160 outputs the instruction values of the steering angle and the vehicle speed to vehicle control device 30 on the basis of the target values of the steering angle and the vehicle speed.

Travel controller 160 controls the steering angle and the vehicle speed on the basis of the instruction value output by vehicle control device 30 while outputting the measured values of the steering angle and the vehicle speed moment by moment. For example, the measured value of the vehicle speed is calculated from the rotational frequency data of the wheel and the circumference length data of the wheel. The measured value of the steering angle may be data obtained from the steering device, or calculated from the inner wheel difference calculated from the difference in rotational frequencies of the wheel.

When there is a difference between the target value and the measured value, travel controller 160 corrects the instruction values of the steering angle and the vehicle speed such that the measured values of the steering angle and the vehicle speed are the same as the target values of the steering angle and the vehicle speed. For example, when the measured value of the vehicle speed is higher than the target value of the vehicle speed, the instruction value of the vehicle speed is set to a value lower than the target value of the vehicle speed, whereas when the measured value of the inner wheel difference is smaller than the inner wheel difference corresponding to the target value of the steering angle, the instruction value of the steering angle is set to a value greater than the target value of the steering angle.

Travel controller 160 tracks the position and orientation of vehicle 1 during traveling on the basis of the measured values of the steering angle and the vehicle speed. Specifically, travel controller 160 calculates the travel trajectory of vehicle 1 during automatic travelling or manual travelling. As the travel trajectory, the movement length, the movement direction, and the angle of the vehicle body may be calculated for each unit time, in the format of movement information added to time. The format of the movement information is not limited to this, and a format using coordinate information may also be adopted, for example.

During automatic travelling, travel controller 160 compares the parking path calculated by path calculator 150 and the travel trajectory represented by the movement information and corrects the steering angle such that the travel trajectory follows the parking path. For example, when vehicle 1 moves backward while turning at a steering angle and the travel trajectory goes outside than the parking path as viewed from the turning center point, travel controller 160 increases the steering angle to reduce the rotation radius. In this manner, the travel trajectory of vehicle 1 is reset toward the parking path.

Note that in automatic parking, it is only necessary to control the steering angle for vehicle 1 to travel along the calculated path, and as such the vehicle speed may be controlled by the driver. For example, the acceleration may be controlled only when the vehicle speed exceeds 5 km/h such that the vehicle can be parked at the driver's preferred vehicle speed as long as the speed is less than 5 km/h. In the present embodiment, the automatic parking is basically performed by automatic travelling (automatic control of the steering angle and the vehicle speed), while an example where automatic parking is performed by automatic steering is also described.

Storage 170 temporarily stores the input data and output data of processes performed by each section of parking assistance device 100 so as to assist the processes of each section. For example, Storage 170 stores image data of the front camera acquired by image acquirer 130 such that parking slot detector 140 can refer to it.

In addition, Storage 170 stores the location information of the parking slot detected by parking slot detector 140 such that path calculator 150 can refer to it. Further, Storage 140 stores the parking path calculated by path calculator 150 such that travel controller 160 can refer to it.

In addition, Storage 170 stores the time point when a front camera image is captured, the time point of steering, and the time point when straight movement is started over the center line of a parking slot, and stores the amount of movement from that time point, such that the location of the own vehicle with respect to the parking slot can be specified at all times even when the position of vehicle 1 changes moment by moment. That is, the processes performed by each section of parking assistance device 100 are organically combined in Storage 170.

Display image indicator 180 generates a display image on the basis of a camera image or a peripheral image. The display image may be a bird's-eye view of the surroundings of vehicle 1 as viewed from above. That is, display image indicator 180 may output a bird's-eye view image as a display image.

Display image indicator 180 displays messages and diagrams in a superimposed manner on a display image in response to a request of state manager 120. For example, at the start of automatic parking, display image indicator 180 may display in a superimposed manner on a bird's-eye view image a semi-transparent rectangle representing the position of the parking slot detected by parking slot detector 140, and display with a dotted line the path from the own vehicle to the target parking position calculated by path calculator 150.

The message may be read aloud as well as displayed on the image. Alternatively, the message may be output only by means of sound.

More specifically, state manager 120 makes an instruction of designating one of texts set in advance and outputting it. In response to the instruction, display image indicator 180 generates an image of character strings corresponding to the designated text, and outputs to HMI device 20 the image in a superimposed manner on the display image, while outputting to HMI device 20 sound data stored with the texts, in combination with the display image. In this manner, the passenger can receive messages even without looking at HMI device 20.

The control procedure from activation of parking assistance device 100 to completion of automatic parking can be outlined with shift of states managed by state manager 120, and processes for each state. States may be set as follows.

State 0 is a vehicle stop state, i.e., a state where a vehicle is stopped. When vehicle 1 starts to travel, the state proceeds to state 1. Parking assistance device 100 inquires the driver about the parking method if there is a parking slot detection instruction. When the driver selects forward parking, the state proceeds to state 2. When the driver selects backward parking, the state proceeds to another routine.

State 1 is a travelling state, and if there is a parking slot detection instruction, the state proceeds to state 2, and, when vehicle 1 is stopped, the state returns to state 0. State 2 is an explanation state, where parking assistance device 100 explains the activation procedure of forward automatic parking, and then proceeds to state 3. State 3 is a detection state, where parking assistance device 100 performs parking slot detection, and then proceeds to the next when a parking slot detected.

State 4 is a detected state, where parking assistance device 100 provides a notification of detection of a parking slot, and then proceeds to the next. State 5 is a reception state, where parking assistance device 100 waits for a parking instruction from the driver while providing a notification of the inquiry of the parking instruction and count down of time allowance. In response to the notification, the driver may perform the parking instruction operation or a rejection operation, or, may perform nothing. The rejection operation is an operation of showing the intention of the driver not to park in the detected parking slot, and when the rejection is detected, the detected parking slot is skipped to move forward. Parking assistance device 100 proceeds to the next when the parking instruction is detected, whereas it returns to state 3 in response to expiration or reception of the rejection operation.

State 6 is an inquiry state, where parking assistance device 100 executes a reception response (vibration of the steering wheel), and if there is an approval operation (release of the steering wheel), parking assistance device 100 proceeds to the next state 7. In the case of detection of the rejection operation or the expiration in state 6, the state returns to state 3. That is, to skip the parking slot, the driver may perform the rejection operation or perform nothing. State 7 is a self-driving state, where vehicle 1 performs automatic travelling on a parking path composed of a straight line and an arc, and then proceeds to the next upon completion. State 8 is a termination state, where parking assistance device 100 provides a notification of completion of the automatic parking, and then terminates the process.

The rejection operation of showing the driver's intention not to park in the detected parking slot may be any of the operation of returning the steering wheel or the blinker lever to the neutral direction, the operation of rotating the steering wheel beyond the predetermined angle, turning off the hazard lamp, or, the operation of the accelerator pedal, and the operation of a button for cancelling the parking instruction, and it is determined that there is a rejection operation when at least one of the above-described operations is detected. The timing of the rejection operation may be shifted backward or forward. In the case where the rejection operation is performed before the inquiry of the parking instruction, it suffices to not receive the parking instruction operation without making the inquiry of the parking instruction. In the case where the parking instruction operation is performed before the rejection operation, the same state as a state where there is no parking instruction may be set by canceling the reception of the parking instruction operation. For example, in the case where a brake operation of decelerating to a slow speed before the steering point is received as the parking instruction operation, the driver can make a skip instruction by depressing the accelerator pedal for acceleration.

Note that the rejection operation may not be the opposite operation of the parking instruction operation, and the cancellation of reception of the parking instruction operation in response to the rejection operation may not be performed. For example, in the case where there are two empty parking slots on the front left side and the vehicle is parked in the second parking slot from the near side, the driver may perform an instruction operation of instructing automatic parking to the left side by turning the blinker to left, and may make a skip instruction by depressing the accelerator for the first reception response (vibration of the steering wheel). Parking assistance device 100 determines that the parking instruction to left is still continued because the blinker is turned to left while receiving the acceleration operation as a rejection operation, and outputs a reception response also at the confirmation point of the second parking slot. In this manner, to park in the second parking slot, it is only necessary to release the hand at the second vibration, and thus automatic parking in the desired parking slot can be achieved even when there are successive empty parking slots.

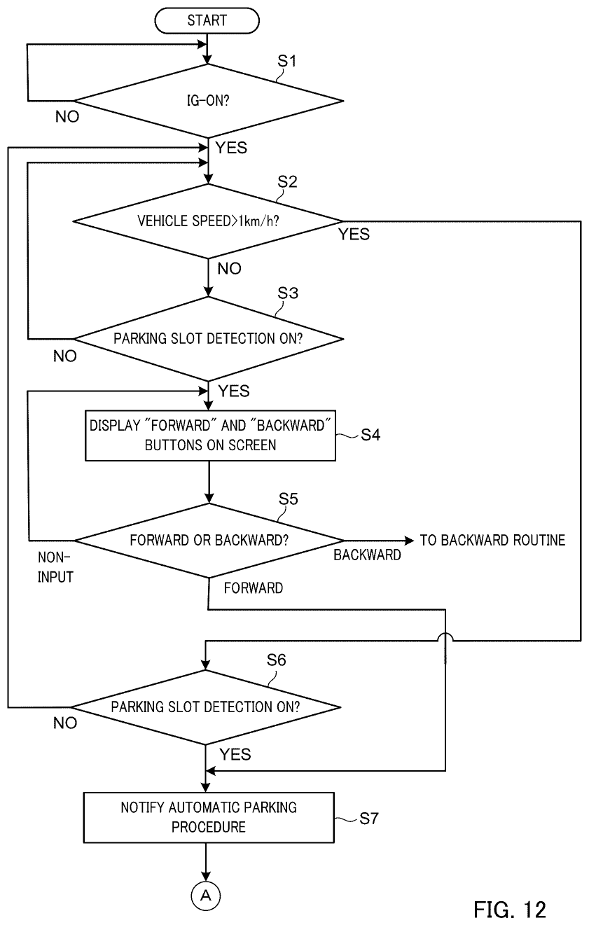

While parking assistance device 100 can execute the backward parking through another routine process, the description of backward parking process (another routine) is omitted in the present embodiment. In the following, the control procedure including detailed description of states is described for each step with reference to FIGS. 12 to 15.

Operation receiver 110 of parking assistance device 100 determines whether the ignition is turned on (step S1). When the ignition is not turned on (step S1, NO), the process is returned to step S1.

When the ignition is turned on (step S1, YES), state manager 120 receives the driver's operation and vehicle state information, and manages the state of the parking assistance. For example, state manager 120 determines whether vehicle 1 is stopped (state 0) or travelling (state 1) by determining whether the vehicle speed is greater than 1 km/h (step S2). In this example, a low vehicle speed of 1 km/h or less is also included in the stop state (state 0).

Next, operation receiver 110 determines whether the parking slot detection button is pushed and the parking slot detection function is turned on when the vehicle speed is 1 km/h or less and vehicle 1 is in the stop state (state 0) (step S2, NO) (step S3). When the parking slot detection function is not turned on (step S3, NO), the process is returned to step S2.

When the parking slot detection function is turned on in the stop state (state 0) (step S3, YES), display image indicator 180 displays “forward” and “backward” buttons on the screen (step S4), thus inquiring the driver whether the driver will make forward parking or backward parking (step S5).

When the driver does not make input of designating forward parking or backward parking (step S5, non-input), the process is returned to step S4. When the driver makes an input of designating the backward parking (step S5, backward parking), state manager 120 executes the backward parking routine process. Parking assistance device 100 of the present embodiment is characterized in the function of performing non-stop forward parking, and therefore the description of processes of backward parking in the stopped state is omitted here.

When the driver makes an input of designating the forward parking (step S5, forward parking), state manager 120 proceeds to the explanation state (state 2), and proceeds to the explanation state (state 2) of providing a notification to the driver the activation procedure of forward automatic parking (step S7).

At step S2, the process proceeds to step S6 when the vehicle is in the travel state (state 1). At step S6, when the parking slot detection function is turned on (step S6, YES), the process also proceeds to the explanation state (state 2) of providing a notification of the activation procedure of forward automatic parking to the driver (step S7).

Specifically, at step S2, when the parking slot detection function is turned on in the state where the vehicle speed is greater than 1 km/h and vehicle 1 is in the travel state (state 1), it is recognized that the forward parking is designated without inquiring the driver.

This is an optimization for the forward parking, which is performed with no stop and during which it is difficult to perform the selection operation during travel, unlike the case where the driver has selected the backward parking, which always involves a stop and during which the selection operation can be performed during the stop.

At step S6, when the parking slot detection function is not turned on (step S6, NO), the process is advanced to step S2 to return to determination of the vehicle speed.

In the explanation state (state 2) of step S7, display image indicator 180 provides a notification of the automatic parking procedure. More specifically, it provides a notification of the procedure of activating the automatic parking for the driver by means of a sound message, and provides a notification of the procedure of activating the automatic parking by means of a display image from the front passenger seat. In the case where the means for making the parking instruction from the front passenger seat is not provided, display image indicator 180 may provide a notification of the procedure of the automatic parking for the driver by means of a display image. Note that the process proceeds to the next step without waiting for the completion of the output of the message.

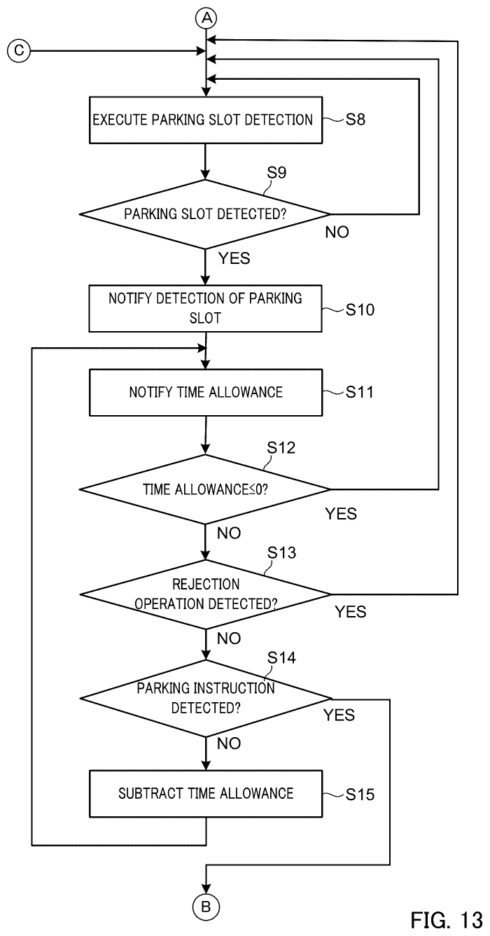

Then, parking slot detector 140 executes the parking slot detection of searching for a parking slot from the front camera image, and proceeds to the detection state (state 3) (FIG. 13, step S8).

Next, parking slot detector 140 determines whether the parking slot is detected (step S9). When the parking slot is not detected (step S9, NO), the process is returned to step S8. When the parking slot is detected (step S9, YES), the process proceeds to the detected state of state 4, and display image indicator 180 provides a notification of detection of the parking slot by means of a sound message (step S10). Note that since the message depends on the position where the parking slot is detected and the parking slot may be detected on both the left and right sides, it is preferable to determine the presence/absence of detection by waiting for the completion of search of both sides without providing a notification at the time point of completion the search of one of left and right detection ranges.

In addition, at step S10, the length of the sound message may be selected in accordance with the time allowance for receiving the parking instruction. The time allowance depends on the vehicle speed, and therefore it may be selected in accordance with the vehicle speed. For example, a notification “Parking slot is detected on the right, do you want to park?” may be provided when the vehicle speed is low, whereas a notification “Want to park right?” may be provided when the vehicle speed is high.

Step S11 to step S15 are processes corresponding to the reception state of state 5, and the parking instruction is received while providing a notification of the time allowance. Specifically, the loop of step S11 to step S15 is performed multiple times while a message of notifying the time allowance is output.

First, display image indicator 180 notifies the driver of the time allowance in the form of one simple number such as “3, 2, 1, 0” as the time allowance, for example. For example, the time allowance is counted down such as “3” for the first loop, and “2” for the next loop (step S11). Note that it is preferable to change the time interval of the notification of each number in accordance with the vehicle speed for the time allowance notification. The reason for this is that the period from the detection of the parking slot to the deadline of the parking instruction is indefinite because it depends on the vehicle speed and the distance to the detected parking slot, and therefore if the notification of the time allowance is started from an indefinite number, it is difficult to explain the operation procedure, and difficult to be understood.

In view of this, for example, in the case where the time allowance is notified as “3, 2, 1, 0”, it suffices to set the interval of the notification as follows: “Notification interval=initial value of time allowance÷4”. In this manner, it is recognized that “Instruction should be given during count of three”.

Next, state manager 120 determines whether there is a notification of “0” as the time allowance (step S12). When “O” is notified as the time allowance (step S12, YES), the reception period of the parking instruction has been completed, and therefore the process returns to step S8 to detect the next parking slot, and, the process proceeds to the detection state (state 3). In the case of not parking due to time expiration, a process of providing a notification of a skip such as “Parking slot skipped”, may be executed before the process is returned to step S8.

When 0 is not notified as the time allowance (step S12, NO), operation receiver 110 determines whether there is a driver's rejection operation for parking (e.g., acceleration operation) (step S13).

When there is a rejection operation (step S13, YES), it is determined that a skip of the parking slot is instructed, and the process is returned to step S8. Note that as at step S12, a process of providing a notification of a skip such as “Parking slot skipped” may be executed before the process is returned to step S8.

When there is no rejection operation (step S13, NO), operation receiver 110 determines whether a parking instruction (e.g., blinker operation) is detected (step S14). When no parking instruction is detected (step S14, NO), state manager 120 performs subtraction of the time allowance (step S15), and returns to step S11 to provide a notification of the updated time allowance.

That is, when there is no time expiration (step S12, NO), no rejection operation (step S13, NO), and no parking instruction (step S14, NO), state manager 120 updates (subtracts) the time allowance at step S15, and returns to the notification process of the time allowance of step S11.

When a parking instruction is detected (step S14, YES), state manager 120 determines whether the parking instruction is valid (step S16). For example, when there is no detected parking slot in the direction of the blinker, it is determined that the parking instruction is not valid, and that it is a rejection operation (step S16, NO), and, the process is returned to step S8. That is, the driver may perform the rejection operation by making an instruction in the opposite direction of an empty parking slot.

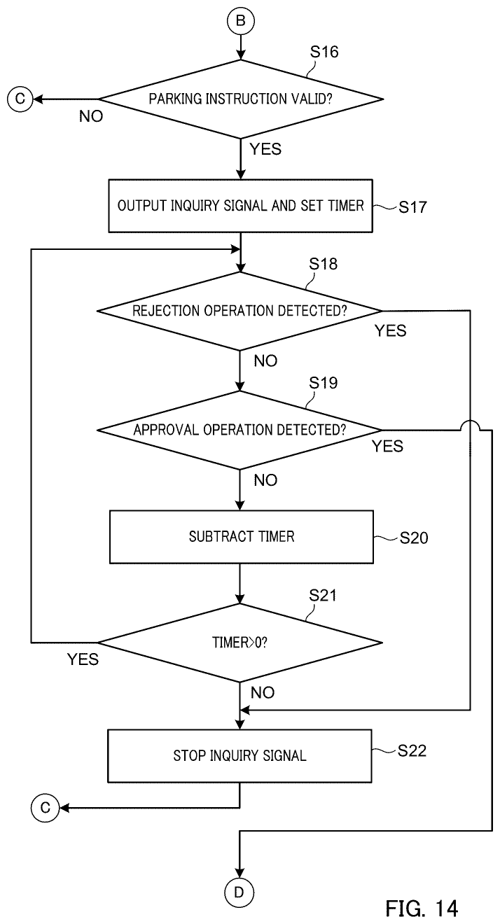

For example, when a parking slot is detected in the direction of the blinker, state manager 120 determines that the parking instruction is valid (in FIG. 14, step S16, YES), and receives the parking instruction, and, proceeds to step S17.

The processes of step S17 to step S22 are processes corresponding to the inquiry state of state 6, and are processes of outputting an inquiry signal (e.g., vibration of the steering wheel) for a certain period to request an approval operation (e.g., release of the steering wheel or reduction of the steering torque).

First, when determining that the parking slot corresponds to the parking instruction operation, state manager 120 outputs an inquiry signal for inquiry of the approval operation. The inquiry signal includes any of vibration of the operation system, sound, and messages. For example, when the steering wheel is vibrated, it suffices for the driver to release the hand from the steering wheel as the approval operation. To manage the reception period of the approval operation, the output period of the inquiry signal is counted with a timer (step S17). Then, state manager 120 determines whether a rejection operation for parking is detected (step S18).

When no rejection operation is detected (step S18, NO), state manager 120 determines whether an approval operation for parking is detected while the inquiry signal is presented (step S19).

When it is determined in the steps up to this point that the parking slot corresponds to the parking instruction operation, that the inquiry signal is output and that there is an approval operation, the automatic parking is started. The approval operation is any of release of the steering wheel, reduction of the steering torque of the steering wheel, release of the brake pedal, and depressurization of the brake pedal, and it is determined that there is an approval operation when at least one of them is detected. That is, it is preferable to determine that there is an approval operation when there are both release of the steering wheel and release of the brake pedal. In this manner, when starting the automatic parking after step S23, the automatic steering and/or the vehicle speed control can be performed without interference by hands or legs of the driver.

When no approval operation is detected (step S19, NO), state manager 120 subtracts the timer (step S20). Then, state manager 120 determines whether the count value of the timer is greater than 0 (step S21).

Then, when the count value of the timer is greater than 0 (step S21, YES), the process is returned to step S18 to continuously repeat the loop. When the count value of the timer becomes 0 (step S21, NO), state manager 120 stops the output of the inquiry signal (step S22) and returns the process to step S8 to perform detection of the next parking slot.

At step S18, when a rejection operation is detected (step S18, YES), state manager 120 immediately determines that a skip instruction of the parking slot is received and stops the inquiry signal (step S22), and, returns to detection of the next parking slot (step S8). Note that a notification of skip such as “skipped” may be added to the process performed at step S22.

The rejection operation may be the same operation as the rejection operation (e.g., acceleration operation) in the reception state of state 5, an operation in the opposite direction of parking instruction (e.g., turning the steering wheel in the opposite direction), or cancellation of the parking instruction (e.g., turning off the hazard lamp). In addition, when no approval operation is performed while the inquiry signal is presented (e.g., not releasing the hand even when the steering wheel is vibrated), the same result as when a rejection operation is performed occurs (step S21, NO), and therefore it suffices to perform any of them when the parking is not desired.

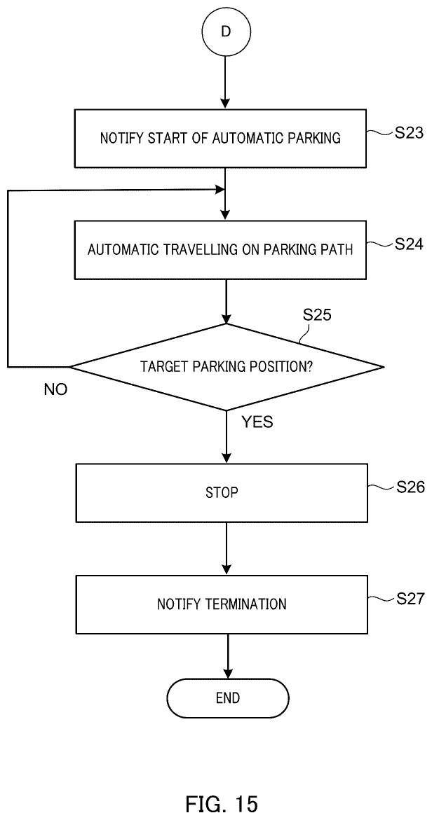

When there is no rejection operation (step S18, NO), and an approval operation is performed while the inquiry signal is presented (step S19, YES), display image indicator 180 provides a notification of the start of the automatic parking (FIG. 15, step S23). The reason that the reception period of the approval operation is limited to the period where the inquiry signal is presented is to start the automatic parking before the vehicle does not go over the predetermined steering point. That is, the automatic parking is started only when there is an approval operation before the vehicle does not go over the predetermined steering point.

The processes from step S23 to step S26 are processes corresponding to the self-driving state of state 7.

First, display image indicator 180 provides a notification such as “Automatic parking is started” indicating the start of the automatic parking to the driver (step S23). Thereafter, travel controller 160 causes vehicle 1 to automatically travel on the parking path (step S24).

In automatic travelling (the self-driving state of state 7), vehicle 1 travels on the parking path calculated by path calculator 150 by automatically controlling the steering angle and the vehicle speed. The parking path is composed of three path portions, namely a straight line portion for moving straight up to a steering point located on the course of vehicle 1, a curved portion for travelling on a circumference from the steering point to the turning end point, and a straight line portion for moving straight from the turning end point to the target parking position.

Since the steering angle and the travel distance are calculated for each path portion, it suffices to travel through a path portion by a predetermined distance at a predetermined steering angle, and then change the steering angle to travel through the next path portion.

Thereafter, by travelling by a predetermined distance through the last path portion for straight movement on the center line of the parking slot, vehicle 1 reaches the target parking position. Travel controller 160 determines whether vehicle 1 has reached the target parking position (step S25).

When vehicle 1 has reached the target parking position (step S25, YES), travel controller 160 stops vehicle 1 (step S26). Thereafter, display image indicator 180 provides a notification “Automatic parking is terminated” to the driver (step S27). Then, the process is terminated when the driver puts the gear in parking and the EPS (electric power steering) is turned OFF (the termination state of state 8).

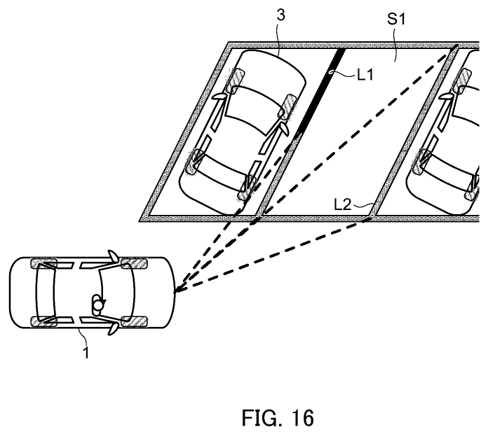

While the procedure of the present embodiment assumes that there is a parking instruction after a detection of an empty parking slot, the following describes a configuration for a case where there is a parking instruction before a detection of an empty parking slot. FIG. 16 is a diagram illustrating a state before a detection of a parking slot.

In FIG. 16, a part of parking slot line L1 of empty parking slot S1 is hidden by parked vehicle 3, and therefore the parking slot is not detected. When vehicle 1 moves forward in this state, first, parking slot S1 can be detected in the front camera image, and then the driver can confirm the inside of parking slot S1, but in some cases the driver performs the parking instruction operation by foreseeing that the vehicle can be parked in parking slot S1 at the time point of FIG. 16 where parking slot S1 is not yet detected.

In view of this, the parking instruction operation may be received also when parking slot S1 is not detected. In such a case, when the parking instruction operation is received but the parking slot corresponding to the parking instruction operation is not detected, the determination whether the parking slot corresponds to the parking instruction operation may be suspended so as to perform the determination when the parking slot corresponding to the parking instruction operation is detected. The reason for this is that if the determination is made when the parking slot is not detected, it is determined that the parking slot does not correspond to the parking instruction operation. This operation may be referred to as postponement of the determination of correspondence until the parking slot corresponding to the parking instruction operation is detected.

The case where the parking slot corresponding to the parking instruction operation is not detected may include a case where no parking slot is detected, a case where a parking slot is detected but it is not located in the direction instructed by the parking instruction operation, and a case where a parking slot is detected but the vehicle has not yet reached the confirmation point of that parking slot. When the parking slot is not detected, it is possible to wait for detection, and when the timing of the parking instruction operation is too early, it is possible to wait for arrival at the confirmation point.

The suspension of the determination may have a deadline. The reason for this that if the suspension of the determination is continued without a deadline, the determination is performed when the driver forgets that the driver has performed the parking instruction operation, which may result in operations not unintended by the driver. In view of this, when a predetermined time has elapsed during the suspension of the determination, or when the vehicle travels by a predetermined distance during the suspension of the determination, the reception of the parking instruction operation is cancelled so as not to perform the automatic parking.

As an example, the reference may be set on the assumption that an instruction of parking is performed 10 m in front of the desired parking slot during the travelling at 3 km/h. The standard (normal) width of parking slots is 2.5 m, and accordingly 10 m corresponds to four slots. Travelling at 3 km/h takes 12 seconds to travel 10 m, and therefore when a predetermined time (e.g., 12 seconds) has elapsed during the suspension, the reception of the parking instruction operation may be cancelled without continuing the suspension so as not to perform the automatic parking. Alternatively, on condition that the vehicle has travelled a predetermined distance (e.g., 10 m) during the suspension, the reception of the parking instruction operation may be cancelled so as not to perform the automatic parking. This can handle a case where the driver performed the parking instruction operation to park in the parking slot three slots ahead. Then, the automatic parking may be performed when the parking slot three slots ahead is empty, and when there is no detection of empty parking slot even after travelling by four slots, a notification that the parking instruction operation has cancelled may be provided at that time point.

The case where the parking slot corresponding to the parking instruction operation has not been detected when the parking instruction operation is received includes the case where the driver's operation is not a parking instruction, and therefore when it is determined that a rejection operation of cancelling the parking instruction operation during the suspension, the reception of the parking instruction operation may be cancelled so as not to perform the automatic parking. For example, when it is determined that there is a parking instruction operation at the time when the steering wheel is turned and the steering angle exceeds the first threshold value (e.g., 10 degrees), and there is no detection of the parking slot in the turning direction of the steering wheel, and, the steering angle exceeds the second threshold value (e.g., 30 degrees), the wheel operation may be determined to be an operation for turning left or right, and the suspension of the determination may be cancelled as there is no parking instruction. The operation of cancelling the parking instruction operation such as setting the steering wheel or the blinker lever to the neutral position and turning off the hazard lamp may be determined to be the rejection operation and subjected to the same process. In the case where the parking is started from the straight movement state, no acceleration is made although deceleration may be made, and therefore an acceleration operation greater than a predetermined threshold value may be determined to be a rejection operation.

The determination reference (e.g., threshold value) of the rejection operation for the suspension of the determination may be the same as the determination reference of the rejection operation for the inquiry signal, but the ease of determination that there is a rejection operation may be increased. That is, when the parking slot corresponding to the parking instruction operation is not detected, the ease of determination that there is a rejection operation may be increased than when the parking slot corresponding to the parking instruction operation is detected. The reason for this is that the disadvantage of the rejection determination is small because when no parking slot is detected, the probability of intent to park is lower and the probability that the rejection determination is against the driver's intention is lower, while when the timing of the parking instruction is too early despite the intention to park, instruction can be requested again upon detection of a parking slot.

For example, since starting automatic parking in the state where the inside of parking slot S1 cannot be confirmed is unsafe, and parking paths cannot be determined in the state where parking slot S1 is not detected, and therefore in state 3 (detection state), i.e., the state where a parking slot detection is activated but parking slot S1 is not detected, the detection of the parking instruction operation may be prohibited as in the control procedure of FIG. 13. In addition, a step of detecting the parking instruction may be inserted between step S9 and step S8 in the control procedure of FIG. 13, and when a parking instruction is detected in that step, it is possible to make a request of confirmation and re-instruction operation such as “For safety, confirm inside parking slot before making parking instruction”. In this manner, prohibition of reception of a premature parking instruction is more likely to be acceptable.

In addition, also in the case where the instruction operation is received and suspended, it is preferable to simultaneously provide a notification. As described above, in the case where a step of detecting the parking instruction operation is inserted at the timing of returning to step S8 in the state where parking slot S1 is not detected (step S9, NO), and a parking instruction is detected at that step, it is preferable to provide a notification that a parking instruction operation is received. Without the notification of the reception of the parking instruction operation to the driver, unnecessary and excessive operation may result, and therefore a notification of the reception of the parking instruction is provided by outputting a message such as “Detection in progress. Please wait”. Thereafter, the procedure may be changed such that the state proceeds to the inquiry state of state 6 (step S17) without performing states 4 and 5 by waiting for the detection of parking slot S1. Even when the timings of the detection of parking slot S1 and the detection of the parking instruction operation are shifted backward or forward, the control after the inquiry state of state 6 may be performed in the same manner.

During the manual operation, the driver must keep an eye on the road ahead, but the passenger of the front passenger seat can look at and operate HMI device 20, and therefore, it is possible to allow the automatic parking function to be operated from the front passenger seat. For example, in the explanation state of state 2, explanatory diagrams and texts may be displayed on the screen of HMI device 20 so as to explain the procedure to instruct the automatic parking for the passenger of the front passenger seat, in addition to the description for the driver by means of sound.

It is possible to adopt a configuration in which a front camera image is displayed on the screen of HMI device 20, and when parking slot S1 (the reception state of state 5) is detected, the image representing detected parking slot S1 is displayed in a superimposed manner so as to receive a parking instruction in response to a touch on the superimposed image (i.e., detected parking slot S1). Detected parking slot S1 is located on either the left or right side or both the left and right sides in the travelling direction of the vehicle, and therefore the operation of touching the screen is an example of the parking instruction operation including the direction instruction.

The parking instruction operation from the front passenger seat may be turning on the hazard lamp, for example. Since the hazard lamp is disposed at a position where it can be operated from the front passenger seat, turning on the hazard lamp may be received as the parking instruction. Turning on the hazard lamp is an example of the parking instruction operation not including the direction instruction. When the parking instruction operation by means of the hazard lamp is performed, and there are parking slots S1 detected on both the left and right sides, it suffices to select left or right on the screen of HMI device 20.

Note that even when a parking instruction is made by the passenger of the front passenger seat, the automatic parking is not started unless the driver performs an approval operation in the inquiry state of state 6, and therefore it can be said that the driver has the final say.

It is possible to perform deceleration in accordance with the parking instruction operation. For example, in the case where there are parking slots on the left and right sides in the travelling direction of vehicle 1, or when the parking instruction operation is the parking instruction operation not including the direction instruction, travel controller 160 may control the vehicle speed such that vehicle 1 does not exceed the predetermined steering point unless the parking instruction operation including the direction instruction is performed. For example, when the parking instruction operation by means of the hazard lamp is performed, and there are parking slots S1 detected on both the left and right sides, deceleration is continued until an operation of selecting left or right is performed on the screen of HMI device 20, or until an operation of selecting left or right is performed by means of the steering wheel or the blinker lever. When the deceleration rate (change in speed in a unit time=acceleration) at this time is set such that the vehicle speed becomes zero on the near side of the predetermined steering point, vehicle 1 does not exceed the predetermined steering point unless the operation of supplying left or right is performed.

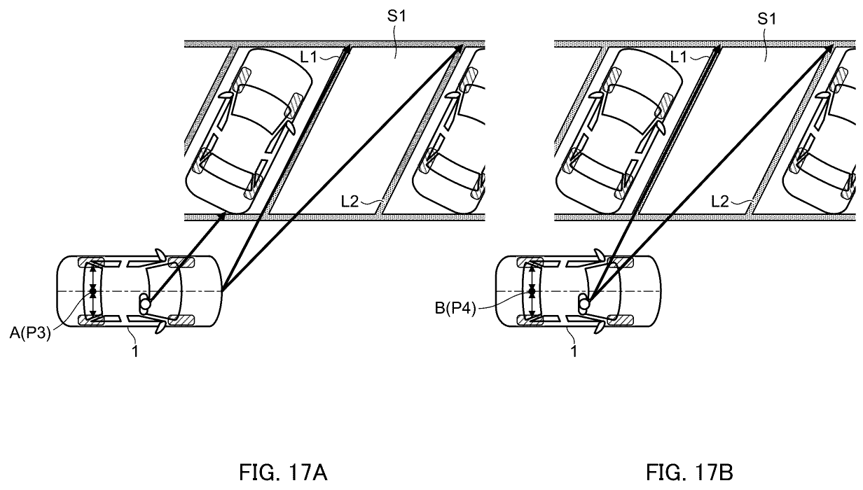

In addition, it is possible to handle the difference in confirmation point for the passenger of the front passenger seat and the driver. FIG. 17A is a diagram illustrating a confirmation point of the passenger of the front passenger seat, and FIG. 17B is a diagram illustrating a confirmation point of the driver. During the manual operation, the driver must keep an eye on the road ahead, and therefore it is preferable to receive the parking instruction operation from the position B (P4) where the inside of parking slot S1 can be visually recognized as illustrated in FIG. 17B. On the other hand, when the front camera image is displayed on HMI device 20, the passenger of the front passenger seat can visually recognize a camera image on HMI device 20 and confirm the safety inside parking slot S1, and therefore it is possible to receive the parking instruction operation from the position A (P3).

For safety, when the parking instruction operation is performed by the driver on the near side of the confirmation point, the parking instruction may not be received, or the response to the reception may be postponed, while the parking instruction operation of the passenger of the front passenger seat may be received with a point where confirmation can be made on the camera image set as the confirmation point. That is, the reception start time of the parking instruction may be changed for the parking instruction by means of HMI device 20 and the parking instruction by means of the steering wheel, the blinker and/or the like.

The fact that the inside of parking slot S1 can be confirmed in the front camera image can be recognized based on the detection of parking slot S1, and therefore it is possible to receive the parking instruction operation after the time point when parking slot S1 is detected. That is, for the parking instruction operation from the front passenger seat, the detection point may be regarded to be the confirmation point.

For example, turning on the hazard lamp, and operations on dedicated buttons and buttons on the screen of HMI device 20, which are the parking instruction operation that can be performed from the front passenger seat, may be received as the parking instruction operation from the time point when parking slot S1 is detected. When parking slot S1 is not detected at the time point when the operation is performed, wait may be requested with an announcement “Please wait” and an inquiry “Do you want to park left?” may be made at the time point when parking slot S1 is detected.

In addition, on condition that the vehicle speed is sufficiently low, even the parking instruction operation that is an instruction operation performed by the driver such as the blinker operation may be received as the parking instruction operation from the time point when parking slot S1 is detected.

In the forward parking, proper parking in detected parking slot S1 cannot be achieved when steering limitation point P1 is exceeded, and therefore it is possible to provide a notification of the time allowance such as “Do you want to park left? 3, 2, 1” in the reception state, and when there is no parking instruction within the time, the process may be returned to the parking slot detection after providing a notification of not performing parking such as “0, parking slot skipped”.

When it is not desired to park in the detected parking slot because the location is far from the entrance of a store or other reasons, the driver may instruct skip by means of the rejection operation without waiting for the time expiration. For example, when the accelerator pedal is depressed in accordance with an inquiry “Do you want to park left?”, it is recognized to be a rejection operation. For the operation on the screen of HMI device 20 from the front passenger seat, pushing a button “NO” displayed on the screen is recognized to be a rejection operation.

In addition, the skip of the parking slot may be performed also in the inquiry state. For example, in the case where the blinker lever has been operated in response to a notification of the parking slot detection, but it is intended to turn toward a passage ahead of the parking slot but not intended as the parking instruction operation, it is only necessary for the driver to not release the hand when the steering wheel is vibrated. In this manner, vehicle 1 determines a grab of the steering wheel to be the rejection operation, and provides a notification of not performing the automatic parking such as “Parking slot is skipped”, then returning to the parking slot detection.

In the inquiry state, as in the reception state, the rejection operation may be performed by depressing the accelerator pedal. The rejection operation in the inquiry state may be an operation of cancelling the parking instruction. For example, in the case where the parking is instructed by means of the blinker lever, returning the blinker lever to the neutral position is recognized to be a rejection operation. When the person in the front passenger seat performs a parking instruction by means of turning on the hazard lamp, turning off the hazard lamp is recognized to be a rejection operation. In addition, the rejection operation may be an operation different from the parking instruction. For example, pressing a “NO” button on the screen of HMI device 20 may be recognized to be a rejection operation regardless of the means of the parking instruction. That is, the person in the front passenger seat may have the right of veto.

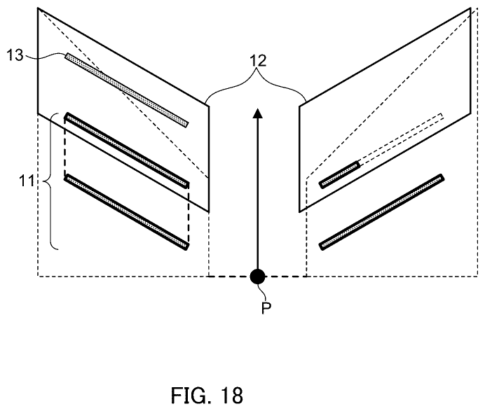

FIG. 18 is a diagram illustrating a configuration for detecting the next parking slot. In the control procedure, the next parking slot is not detected until skip is selected, but the next parking slot may be detected without waiting for skip. For example, when parking slot 11 is detected, the parking slot may be detected with estimated range 12 of a parking slot ahead set as the parking slot detection region.

When parking slot 11 is detected, it is preferable to estimate position 13 of the next parking slot line as illustrated in FIG. 18. More specifically, it is preferable to estimate position 13 of the next parking slot line on the basis of the interval and the position of the slot line of detected parking slot 11, and set the parking slot detection region so as to include it. Alternatively, the parking slot detection may be repeated for each 1 m forward movement in accordance with the forward movement of the vehicle. When the parking slot detection is continuously executed, the next parking slot is detected in some situation before the parking slot is skipped. By detecting the next parking slot in advance, when one parking slot is skipped, the process can be optimized in accordance with the presence/absence of the next parking slot.

For example, when the next parking slot has been detected, a message that is different than when the next parking slot has not been detected may be output. More specifically, when the next parking slot has been detected, the message of a notification of skip may be shortened. In this manner, before the output of the message proposing automatic parking to the next parking slot, the output of the message of the notification of skip can be completed. That is, it is possible to avoid a situation where due to the former message being output, the output of the message proposing automatic parking to the next parking slot is delayed, or a message notifying skip is turned off in the middle of the message, thus resulting in incomplete messages.

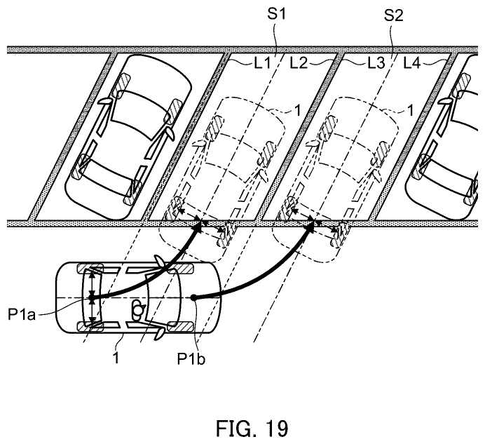

FIG. 19 is a diagram for describing a message output for a case where there are successive empty parking slots. When parking slot S1 and parking slot S2 are empty in a successive manner, steering limitation point P1a of parking slot S1 and steering limitation point P1b of parking slot S2 are set, and an announcement requesting a parking instruction corresponding to the respective steering limitation points is made.

When parking slot S1 is skipped in the state where parking slot S2 is not detected, the announcement “Do you want to park? 3, 2, 1, 0, skipped” is made, but when next parking slot S2 is detected in the middle of the announcement “Skipped”, it is necessary to inquire that “Do you want to park?” by turning off the “skipped” in the middle of it such that the driver's operation is performed before steering limitation point P1b. In view of this, when the next parking slot is detected in advance and parking slot S2 has been detected, a notification “Do you want to park? 3, 2, 1, 0, do you want to park? 3, 2 . . . ” may be provided by shortening or omitting the notification of skip, for example.

It is assumed that the interval of the steering limitation point is 2.5 m, and the vehicle speed is 3 km/h, for example. In this case, the vehicle passes through the steering limitation point every 2.5 m÷(3 km/3600 seconds)=3 seconds, and therefore a minimum 3-second message “do you want to park? 3, 2, 1, 0” may be created in advance, and “skipped” may be inserted when there are no successive empty parking slots, for example. In addition, the length of the output message may be changed in accordance with the vehicle speed, and the vehicle speed may be controlled to 3 km/h or less in view of the fact that the message output requires at least three seconds.

While the control of requesting approval of the automatic parking in the inquiry state of state 6 is described above, the approval of the automatic parking may not be required, and the automatic parking may be immediately started in response to the parking instruction. For example, when the parking slot detection function is activated during travel and a white line approximately parallel to the travelling direction is detected on the left and right sides in the travelling direction, the region between the left and right white lines may be recognized to be a passage, and a function of travelling at the center of the passage through automatic steering may be activated. That is, the automatic steering may be started in the phase of travelling on the passage while performing the parking slot detection. In addition, the automatic travelling that performs the automatic control including the vehicle speed may be started. In the case where the automatic travelling has already been started, it is not necessary to request the approval again at the start of the automatic parking.

The automatic steering assumes that the driver releases the steering wheel (no steering force is applied to the steering wheel), and therefore it is preferable to perform notification of the automatic steering and confirmation of the approval operation (of releasing the steering wheel) at the start of the automatic steering. In the case where the driver has performed a parking instruction by means of the blinker lever while travelling on a passage through the automatic steering, the steering wheel has already been released, and therefore it is not necessary to request the approval operation (of releasing the steering wheel) for the purpose of starting the automatic parking.

In the case where the driver controls the vehicle speed during the travel on the passage whereas the vehicle speed is also automatically controlled during the automatic parking, it is necessary to release the pedal at the start of the automatic parking, but it is not necessary to release the pedal in the case where the vehicle speed is not automatically controlled even during the automatic parking. In addition, also in the case where the passage travelling is the automatic travelling (both the steering angle and the vehicle speed are automatically controlled), it is not necessary to release the pedal. In the case where the approval is unnecessary, and it is determined that a parking instruction is received in the reception state of state 5, the state may proceed to the self-driving state of state 7 without performing the inquiry state of state 6.

Naturally, it is not preferable to change the behavior of the vehicle without notification to the driver, and it is better to provide a notification of the start of the automatic parking even when the approval of the automatic parking is not requested, and therefore, the state may proceed to the self-driving state of state 7 after providing a notification of the start of the automatic parking at state 6.

Note that in general, notifications may be taken as bothersome by the driver, and especially a notification of time allowance may be disliked because it takes away psychological allowance. In view of this, a configuration for increasing psychological allowance may be additionally provided.

In the forward parking, a steering limitation point is located on the near side of the detected parking slot, and the vehicle cannot be properly parked in the detected parking slot if the steering limitation point is exceeded, and as such the time allowance before the approval operation is limited. In view of this, it is preferable to increase the time before the steering limitation point by decelerating the vehicle when the parking instruction operation is performed. This increases the time allowance, as well as psychological allowance. For example, in the case where there are detected parking slots on the left and right sides at the time of turning on the hazard lamp, the operation of selecting left or right is not required, and therefore it is possible to automatically decelerate in response to turning on the hazard lamp so that left or right can be selected in time.

Automatic deceleration and deceleration instruction in response to the parking instruction operation are effective also in the case where the driver performs the parking instruction operation by means of the blinker or the steering wheel. In the case where the parking instruction operation is performed by means of the blinker or the steering wheel, deceleration through brake operation by the driver may be set as a condition of reception of the parking instruction operation, and automatic deceleration may be performed in response to the parking instruction operation.

Alternatively, since the lateral acceleration felt by passengers due to steering should be suppressed, a condition that a vehicle speed is equal to or smaller than a predetermined threshold value may be added to the detection condition of the parking instruction operation. For example, when both deceleration to a slow speed and the blinker operation are performed, it may be determined that the parking instruction operation is detected. In this manner, a sufficiently decelerated state at the time when the parking instruction operation is detected can be achieved. Alternatively, the driver may instruct deceleration. When the parking instruction operation is performed and the vehicle speed is greater than a predetermined threshold value, an announcement “Decelerate” may be made, and if the vehicle speed does not set to equal to or smaller than the predetermined threshold value, the automatic parking may be started with an announcement “Speed was too high”. In addition, when a parking slot or the parking instruction operation is detected, and the vehicle speed is greater than a predetermined value (e.g., 10 km/h), the travel controller may automatically decelerate the vehicle so that the vehicle speed is set to equal to or smaller than the predetermined threshold value.

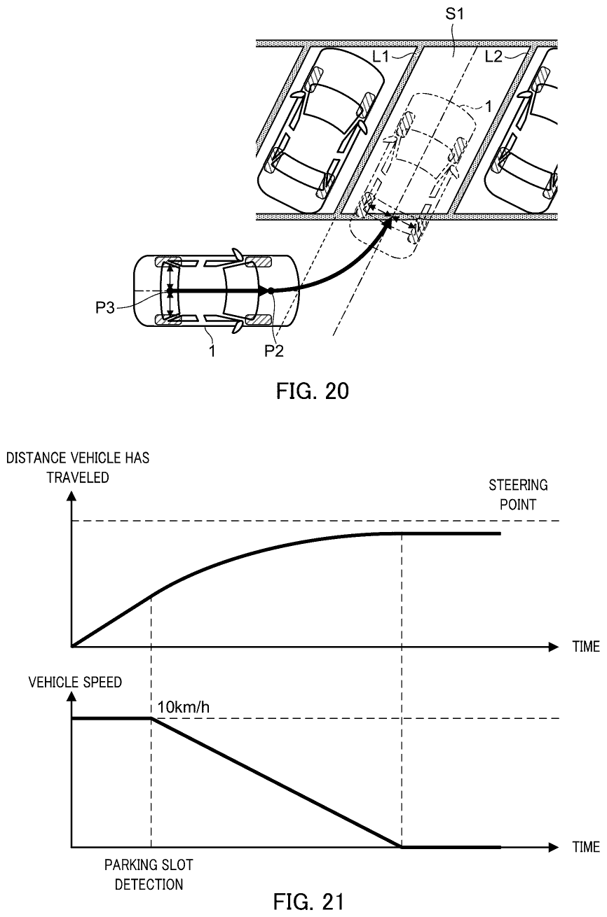

FIG. 20 is a diagram for describing a configuration of starting deceleration when a parking slot is detected. In the case where the vehicle travels in a parking lot at a relatively high speed (e.g., per hour 15 km) looking for an empty parking slot, starting deceleration at the time point of the parking instruction operation may not sufficiently decelerate before the start of steering, or deceleration before the start of steering may result in rapid deceleration, which may be uncomfortable for the passengers.

In view of this, the vehicle speed may be compared with a predetermined threshold value at the time point when parking slot S1 is detected, and automatic deceleration may be performed when the speed is greater than the predetermined threshold value, or a notification that the automatic parking cannot be started may be provided to the driver to request deceleration when the vehicle speed is high.

When the deceleration is started at the position (detection point P3) where the parking slot is detected, it is only necessary to decelerate while travelling the distance to steering point P2, and thus the deceleration rate (acceleration) can be suppressed, and, the centrifugal force (acceleration) felt by the passenger can be reduced with the suppressed vehicle speed at the start of turning.

The deceleration at the time of detection of an empty parking slot and the deceleration in response to a parking instruction may be used in a shared manner. For example, the deceleration may be started at the time point of the detection of an empty parking slot or the parking instruction earlier than the other, or deceleration to 10 km/h or less may be performed when an empty parking slot is detected, or, deceleration to 5 km/h or less may be performed when a parking instruction is made.

In addition, the vehicle speed may be monitored while the parking slot detection function is operating, so as to request deceleration by providing a notification that the automatic parking is not performed to the driver when the vehicle speed is greater than a predetermined value. For example, by providing a notification “Parking slot detection will not be performed at 10 km/h or greater” when the travelling speed is greater than 10 km/h, and providing a notification “Parking slot detection starting” when the travelling speed becomes lower than 10 km/h, the driver decelerates to a speed lower than 10 km/h when the vehicle comes close to the desired parking slot.

In the forward parking, steering point P2 is located on the near side of detected parking slot S1, and the vehicle cannot be parked in the detected parking slot if the vehicle goes over the steering point P2, and as such, a notification of the time allowance is provided by count down “Do you want to park left? 3, 2, 1” in the reception state of state 5 in the above-described example. However, many people feel uncomfortable with such a sense of urgency, saying, “I don't like feeling like being rushed”.

In view of this, the vehicle speed may be controlled such that the vehicle does not go over the predetermined steering point until the parking instruction operation is received. The notification of the time allowance may be made necessary by decelerating the vehicle such that the vehicle does not go over steering point P2. More specifically, deceleration is automatically performed from the time point when parking slot S1 is detected, and the deceleration rate is set such that the vehicle speed is set to zero (stop) on the near side of steering point P2. Then, if the driver's decision is delayed and the state with neither the parking instruction nor the rejection operation continues, the vehicle stops on the near side of steering point P2. That is, when the deceleration is performed so that the vehicle does not go over steering point P2, the time allowance becomes infinite, and therefore there is no need to provide the notification of the time allowance.

FIG. 21 is a diagram illustrating a configuration of performing deceleration so that the vehicle does not go over steering point P2. For example, steering point P2 is set on the near side of steering limitation point P1 at the time point when parking slot S1 is detected, and a deceleration rate is set such that the speed becomes zero on the near side of steering point P2 when the deceleration is performed with the constant deceleration rate. In the case where the deceleration is performed at a constant deceleration rate as shown in the lower graph, the distance traveled by the vehicle becomes a quadratic curve as shown in the upper graph, and the vehicle speed becomes zero before steering point P2 and stops. When the vehicle stops, the time constraint is eliminated, and the driver can safely make the parking instruction because there is no problem with the driver looking at the screen of HMI device 20 for confirmation.

Even with this type of control, the vehicle does not necessarily temporarily stop, such that the system shifts to automatic parking without stopping when the parking instruction is made before the vehicle stops, and that automatic parking starts in a non-stop manner when the driver operates the system quickly.

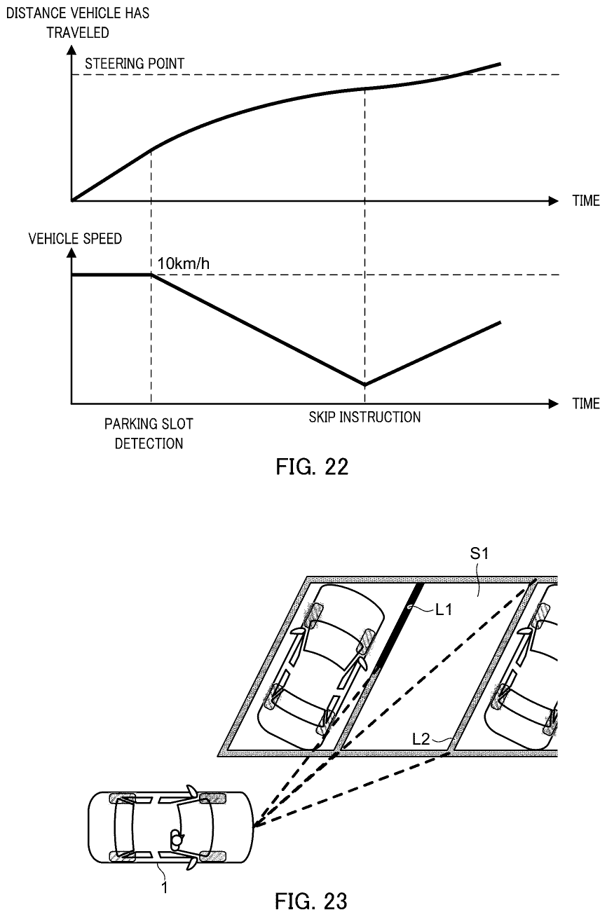

FIG. 22 is another diagram illustrating a configuration of performing deceleration so that the vehicle does not go over steering point P2. This figure illustrates a graph of a case where a skip of the parking slot is instructed before the vehicle stops, and when a skip is instructed, the vehicle does not temporarily stop because the vehicle reaccelerates to go toward the next parking slot. This speed control allows for favorable usability while avoiding the discomfort caused by reporting the time allowance.

Such a configuration of performing deceleration so that the vehicle does not go over steering point P2 may be applied to the inquiry state of state 6. Specifically, until the operation system is released, the vehicle speed is controlled such that the vehicle does not go over the predetermined steering point. In the flow chart of FIG. 14, when a predetermined time (e.g., one second) elapses after the output of the inquiry signal, the parking slot is skipped, and therefore it is necessary to immediately perform the approval operation (e.g., release of the steering wheel). However, by decelerating the vehicle so that the vehicle does not go over steering point P2 until the approval operation and/or the rejection operation is detected, the upper limit of the time to wait for the driver's operation may be eliminated.

For example, the person who is anxious to release the hand from the steering wheel during travel of the vehicle may release the hand when the vehicle stops on the near side of steering point P2, and the person familiar with it may immediately release the steering wheel in response to vibration of the steering wheel and start the automatic parking with minimum deceleration without stopping the vehicle. In addition, to skip a slot, it is only necessary to go to the next slot by depressing the accelerator without waiting for the stop of the vehicle.

In addition, the speed may be controlled in accordance with the state of the parking lot. In parking lots where forward parking is a prerequisite, parking slots are often set so that the travelling direction of vehicle 1 and the central axis of the parking slot are at an acute angle, and parking slots that can be parked are sometimes set on only one side of the passage. For example, a parking slot whose central axis is at an obtuse angle to the travelling direction of the vehicle is a parking slot set to be entered from another passage.

In view of this, the parking slot detection in forward parking evaluates the angle between the travelling direction of the vehicle and the central axis of the parking slot, and when the angle is an obtuse angle, it is not detected as a parking slot. In addition, parking slots located on the side convenient for use tend to be filled first, and therefore the probability that parking slots are available on both sides of the passage is lower than the probability that parking slots are available on only one side of the passage.

As such, the convenience loss can be relatively small even if deceleration is made stronger or the car is stopped so that time can be taken to select the left or right side only in a case where there are the detected parking slots on both the left and right sides. For example, if the hazard lamp is turned on and the detected parking slot is on both the left and right sides, the driver may decelerate to a lower speed than if the detected parking slot is on one side or the other, or the driver may stop or decelerate at a deceleration rate that does not exceed the turning limit point.

In addition, the deceleration control may be changed depending on whether the parking instruction operation is performed through the driver's operation (the operation by means of the steering wheel or the blinker), or through the operation (the operation by means of the hazard lamp or HMI device 20) performed by the passenger of the front passenger seat.

The driver can support the body by the steering wheel, but when deceleration is performed while the person in the front passenger seat performs operation on the screen of HMI device 20, the body is destabilized due to the acceleration, and the buttons on the screen may not be properly pushed, for example. In view of this, in the case where parking slots are detected on the left and right sides and the parking instruction includes no direction instruction, left or right may be selected after a stop or the deceleration rate may be reduced so that the body is not destabilized due to the acceleration until a parking instruction including a direction instruction is performed.

For example, in the case where the parking instruction is the hazard lamp, the vehicle may be unconditionally stopped and a button for selecting left or right may be displayed on the screen after the stop such that all operations before the start of the automatic parking are performed during the stop. In the vehicle stop state, the driver can look at and operate the screen as desired. Since there are fewer cases where the parking instruction operation is performed by the person in the front passenger seat than the case by the driver, the loss of convenience is relatively small even if the system is made to definitively stop the vehicle.

FIG. 23 is a diagram illustrating a configuration for a case where a parking instruction is made by the driver through steering wheel operation. When the parking instruction operation is performed through steering wheel operation and the driver's steering point is valid as the steering point, it may shift to automatic parking with that point as the steering point. It should be noted that it is assumed that the parking path can be calculated at the time of steering because the driver's steering point cannot be estimated. In other words, if the parking path cannot be calculated at the time of steering, it cannot shift to automatic parking with that time point as the steering point. In addition, the point where the driver has performed the steering may not be valid as the steering point.

As illustrated in FIG. 23, when the parking instruction operation is performed through the steering wheel operation at a remote location on the near side of parking slot S1, the parking path for properly parking in parking slot S1 cannot be set if steering is performed at the steered point of the driver. In such a case, it is necessary to keep the advancing direction without performing the steering. Specifically, in the case where the parking path cannot be set, it is necessary to issue an alert “You cannot park from here”, or maintain the advancing direction by generating a reactive force against the steering at the EPS.

In the case where the path calculation is performed by setting the steering point in advance as described above, it is preferable to receive the driver's steering wheel operation only as a parking instruction. That is, since it is assumed to perform steering at the planned steering point, the advancing direction is maintained against the driver's steering wheel operation.

It should be noted that in some situation the steering wheel may be operated for the purpose of avoidance of unsafety or right/left turn at the passage, and therefore control precautions must be taken to avoid insecurity. For example, it is possible to adopt a configuration in which when the steering wheel is turned slightly with a small steering force, the EPS is controlled to generate a reaction force against the steering to maintain the course, but when the steering force exceeds a threshold value, the EPS is controlled not to generate the reaction force.

If the steering wheel is turned, the driver may not be able to follow the calculated path because the path may change even if the steering wheel is reversed by reaction force. Therefore, the necessary condition for the parking instruction by the steering wheel may be “Swing to the left and return to neutral” or “Swing to the right and return to neutral”. In this manner, the steering wheel is accepted as a parking instruction when the steering wheel is neutral and the path is back on track, which makes it easier to calculate the path with the steering wheel turned. The “Swing back” operation is also preferable in that it can be distinguished from the operation for hazard avoidance and right or left turn.

Other forms that can be achieved by making various modifications to each of the embodiments, or by arbitrarily combining the components and functions in each embodiment to the extent that the intent of this disclosure is not departed from, are also included in this disclosure.

This application is entitled to and claims the benefit of Japanese Patent Application No. 2023-118336 filed on Jul. 20, 2023, the disclosure each of which including the specification, drawings and abstract is incorporated herein by reference in its entirety.

### INDUSTRIAL APPLICABILITY

The present disclosure is applicable to parking assistance devices and parking assistance methods.

### REFERENCE SIGNS LIST

1 Vehicle
2 Camera
10 Operation device
20 HMI device
30 Vehicle control device
40 Navigation device
100 Parking assistance device
101 CPU
102 ROM
103 RAM
104 I/O
105 IMP
110 Operation receiver
120 State manager
130 Image acquirer
140 Parking slot detector
150 Path calculator
160 Travel controller
170 Storage
180 Display image indicator

1. A parking assistance device comprising:
a parking slot detector that detects a parking slot;
an operation receiver that receives a parking instruction operation of a passenger of a vehicle; and
a travel controller that performs automatic parking of the vehicle in a parking slot corresponding to the parking instruction operation,
wherein when the parking slot is located on only one of left and right sides in a travelling direction of the vehicle, or when the parking instruction operation is a parking instruction operation including a direction instruction and the parking slot is located in a direction instructed by the parking instruction operation, in a case where the parking slot is located in a predetermined range in the travelling direction of the vehicle, it is determined that the parking slot corresponds to the parking instruction operation.

2. The parking assistance device according to claim 1,
wherein the parking instruction operation includes at least one of an operation of rotating a steering wheel, an operation of moving down a blinker lever, turning on a hazard lamp, an operation of a brake pedal, and an operation of a predetermined button, and
wherein the parking instruction operation including the direction instruction includes at least one of the operation of rotating the steering wheel, the operation of moving down the blinker lever, and the operation of a predetermined button.

3. The parking assistance device according to claim 1, wherein when the parking slot is located on only one of the left and right sides in the travelling direction of the vehicle, the parking instruction operation does not include the direction instruction, and the parking slot is located in the predetermined range in the travelling direction of the vehicle, it is determined that the parking slot corresponds to the parking instruction operation.

4. The parking assistance device according to claim 1, wherein when the parking instruction operation is received and the parking slot corresponding to the parking instruction operation is not detected, determination whether the parking slot corresponds to the parking instruction operation is suspended.

5. The parking assistance device according to claim 4, wherein when a predetermined time has elapsed during suspension of the determination, or when the vehicle has travelled a predetermined distance during suspension of the determination, reception of the parking instruction operation is cancelled, and the automatic parking is not performed.

6. The parking assistance device according to claim 1,
wherein when at least one of an operation of returning a steering wheel or a blinker lever to a neutral direction, an operation of rotating the steering wheel beyond a predetermined angle, turning off a hazard lamp, an operation of an accelerator pedal, and an operation of a button for cancelling the parking instruction is detected, it is determined that a rejection operation is performed, and
wherein when the rejection operation is performed, the automatic parking is not performed.

7. The parking assistance device according to claim 6, wherein when the parking slot corresponding to the parking instruction operation is not detected, ease of determination that the rejection operation has been performed is increased than when the parking slot corresponding to the parking instruction operation is detected.

8. The parking assistance device according to claim 1,
wherein a predetermined steering point corresponding to a parking slot detected by the parking slot detector is set, and
wherein the predetermined steering point is a turning start position of a path for the vehicle to park within the parking slot, and
wherein a terminal end of the predetermined range is set based on the predetermined steering point.

9. The parking assistance device according to claim 8, wherein the travel controller controls a vehicle speed such that the vehicle does not go over the predetermined steering point until the parking instruction operation is performed.

10. The parking assistance device according to claim 1,
wherein a predetermined confirmation point corresponding to the parking slot detected by the parking slot detector is set,
wherein the predetermined confirmation point is a point where a passenger of the vehicle is able to confirm inside of the parking slot, and
wherein a starting end of the predetermined range is set based on the predetermined confirmation point.

11. The parking assistance device according to claim 10, wherein when the parking instruction operation is performed by the passenger on a near side of the predetermined confirmation point, the parking instruction is not received, or response to reception of the parking instruction is postponed.

12. The parking assistance device according to claim 10, wherein the point where the passenger of the vehicle is able to confirm the inside of the parking slot is set based on a positional relationship between a head of the passenger or a camera provided in the vehicle, and an extension of a long side of the parking slot.

13. The parking assistance device according to claim 1, wherein when a vehicle speed of the vehicle exceeds a first predetermined value, the automatic parking is not performed.

14. The parking assistance device according to claim 1, wherein when the parking slot is detected or when the parking instruction operation is detected, in a case where a vehicle speed of the vehicle is greater than a second predetermined value, the travel controller decelerates the vehicle.

15. The parking assistance device according to claim 1,
wherein the automatic parking is started when it is determined that the parking slot corresponds to the parking instruction operation and an approval operation is performed, and
wherein when the operation receiver detects at least one of release of the steering wheel, reduction of a steering torque of the steering wheel, release of a brake pedal, and depressurization of the brake pedal, it is determined that the approval operation is performed.

16. The parking assistance device according to claim 15,
wherein when it is determined that the parking slot corresponds to the parking instruction operation, an inquiry signal for inquiry of the approval operation is output, and
wherein the inquiry signal includes any of vibration of an operation system, sound, and a message.

17. The parking assistance device according to claim 15, wherein when the approval operation is performed before the vehicle goes over a predetermined steering point, the automatic parking is started.

18. The parking assistance device according to claim 15, wherein a vehicle speed of the vehicle is controlled such that the vehicle does not go over a predetermined steering point until the approval operation is performed.

19. A parking assistance method comprising:
detecting a parking slot;
receiving a parking instruction operation of a passenger of a vehicle;
determining that the parking slot corresponds to the parking instruction operation when the parking slot is located on only one of left and right sides in a travelling direction of the vehicle, or when the parking instruction operation is a parking instruction operation including a direction instruction and the parking slot is located in a direction instructed by the parking instruction operation, in a case where the parking slot is located in a predetermined range in the travelling direction of the vehicle; and
performing automatic parking of the vehicle in a parking slot corresponding to the parking instruction operation.

20. A parking assistance recording medium that causes a computer to execute:
detecting a parking slot;
receiving a parking instruction operation of a passenger of a vehicle;
determining that the parking slot corresponds to the parking instruction operation when the parking slot is located on only one of left and right sides in a travelling direction of the vehicle, or when the parking instruction operation is a parking instruction operation including a direction instruction and the parking slot is located in a direction instructed by the parking instruction operation, in a case where the parking slot is located in a predetermined range in the travelling direction of the vehicle; and
performing automatic parking of the vehicle in a parking slot corresponding to the parking instruction operation.
